(19) United States
(12) Patent Application Publication
(10) Pub. No.: US 2026/0030307 A1
(43) Pub. Date: Jan. 29, 2026

(54) AUTOMATIC SORTING OF FILE NODES

(71) Applicant: Cactus Block LLC, Syracuse, NY (US)

(72) Inventors: Michael Gursha, New York, NY (US); Douglas Gursha, New York, NY (US)

(21) Appl. No.: 19/248,257

(22) Filed: Jun. 24, 2025

Related U.S. Application Data
(60) Provisional application No. 63/675,845, filed on Jul. 26, 2024.

(51) Int. Cl. G06F 16/9538; G06F 16/14; G06F 16/22

(52) U.S. Cl. CPC G06F 16/9538; G06F 16/14; G06F 16/2246

(57) ABSTRACT

Systems and methods are provided for automatic file sorting. A method for automatic file sorting is executed via processor based on instructions stored on non-transitory memory of the processor and includes analyzing contents of file nodes, generating metadata for each of the file nodes based on the analyzed contents, generating one or more tree structures corresponding to the file nodes based on the generated metadata, and determining a placement of the file nodes into folders of the one or more tree structures based on the generated metadata.

### CROSS REFERENCE TO RELATED APPLICATIONS

The present application claims priority to U.S. Provisional Application No. 63/675,845 entitled “AUTOMATIC SORTING OF FILE NODES”, filed on Jul. 26, 2024. The entire contents of the above-identified application is hereby incorporated by reference for all purposes.

### FIELD

The disclosure relates generally to automatically sorting content to be visually arranged and consumed stored on a content management system.

### BACKGROUND

Content management systems (CMSs) are used to deliver content through a number of digital channels. A CMS may be stored and executed locally or remotely via the cloud. For example, the CMS may be a web-based application. Such content management systems have been utilized for the creation and modification of digital content, such as publication of content as a website on the Internet. Conventionally, an author may store content of a webpage in a CMS and tags are assigned to the content of the webpage such as text, pictures, videos, etc. by the author. However, tags may be subject to human interpretation and a webpage may remain untagged if an author forgets or neglects to add tags. Additionally, an author may wish to import pages of an existing website into a CMS and the imported pages may not include tags. Manually adding tags to content may quickly become tedious and may be prone to errors. Further, a user cannot consider the entire contents of a website as whole to generate tags which can be used to relate each piece of content within the CMS. Even if tags are automatically added, the tags may not be directly related to the site structure and/or organization of the webpage, such that the construction of a webpage based on the tags demands further manual intervention. Further, tags may demand constant changing and updating as content is added to the CMS.

### SUMMARY

A folder-based content management system and associated methods are provided to organize large quantities of content. In one example, a method of an automatic file sorting system executed via a processor based on instructions stored on non-transitory memory of the processor, includes: analyzing contents of file nodes comprising content to be visually arranged and consumed, generating metadata for each of the file nodes based on the analyzed contents, the metadata including one or more descriptive metadata, structural metadata, and administrative metadata; generating one or more tree structures corresponding to the file nodes based on the generated metadata, the one or more tree structures each including a root folder and one or more sub-folders providing a relational data structure; placing the file nodes into the one or more sub-folders of the one or more tree structures based on generated metadata; and outputting a visual arrangement of the contents of the file nodes to a display, wherein the visual arrangement is based on a placement of the file nodes into the one or more sub-folders. File nodes may be automatically sorted into one or more tree structures the file structure corresponds to the visual arrangement of the content of the files. In this way, the one or more tree structures both organize the file nodes and the organization is transformed into visual content. The one or more tree structures operate in a way that is not expected of a file structure. The one or more tree structures may be organizational structures including, but not limited to, nodal structures, web-likes structures, and 3D structures. The one or more tree structures may be used to automatically generate visually consumable content such as a website and may be used as a headless CMS.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 shows a block diagram illustrating an example networked computing system for automatically generating a visually arranged and consumed content;

FIG. 2 shows a block diagram of a system for generating the visually arranged and consumed content including an automatic file sorting system and a visual display generation module;

FIG. 3A shows a flowchart of an example of a method for reading a file system and its folders and files;

FIG. 3B shows a flowchart of an example of a method for resynchronizing folders and files as part of the method of FIG. 3A;

FIG. 4 shows a flowchart of an example of a method for generating metadata for file nodes of a tree structure;

FIG. 5 shows a flowchart of an example of a method for automatically generating the tree structure based on metadata of file nodes;

FIG. 6 shows a flowchart of an example of a method for automatically sorting file nodes in the tree structure;

FIG. 7 shows a flowchart of an example of a method for automatically placing file nodes in the tree structure;

FIG. 8 shows a block diagram illustrating an example of a machine learning and/or artificial intelligence system for automatic file sorting;

FIG. 9A shows an example of miss-sorted content in a tree structure;

FIG. 9B shows an example of a website generated from the miss-sorted content shown in FIG. 9A;

FIG. 10A shows an example of correctly sorted content in the tree structure;

FIG. 10B shows an example of a website generated from the sorted content of the tree structure of FIG. 10A;

FIG. 11A shows an example of a tree structure including a root folder and not including sub-folders;

FIG. 11B shows an example of a website generated from the tree structure of FIG. 11A;

FIG. 12A shows an example of the tree structure including a root folder and sub-folders;

FIG. 12B shows an example of a website generated from the tree structure of FIG. 12A;

FIG. 13A shows an example of a tree structure including a root folder and not including sub-folders;

FIG. 13B shows an example of a plurality of tree structures; and

FIG. 14 shows an example of a selection of third party software application file nodes.

FIG. 15 shows an example of a neural network of the automatic file sorting system.

### DETAILED DESCRIPTION

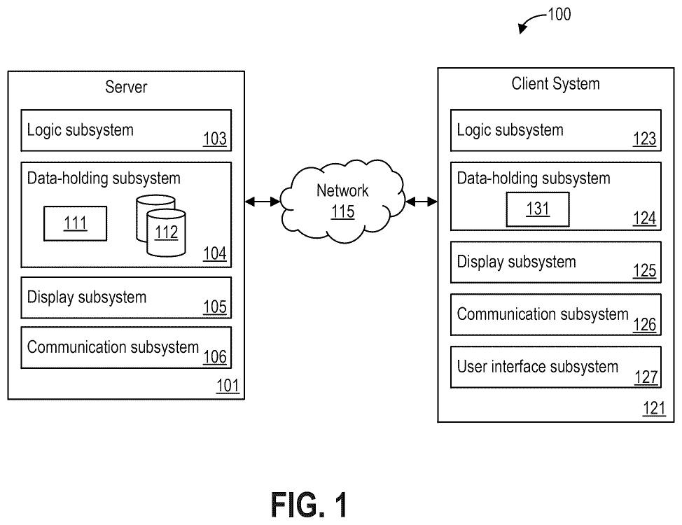

The following description relates to various embodiments of a system and methods for automatically sorting visually arranged and consumed content, such as a website, stored in a CMS. A website is used herein as an exemplary, non-limiting embodiment of visually arranged and consumed content. Other examples of visually arranged and consumed content include an ad server, mobile application, application programming interface (API), or other type of computer application. The system may be included in a networked computing system such as the networked computing system shown in FIG. 1.

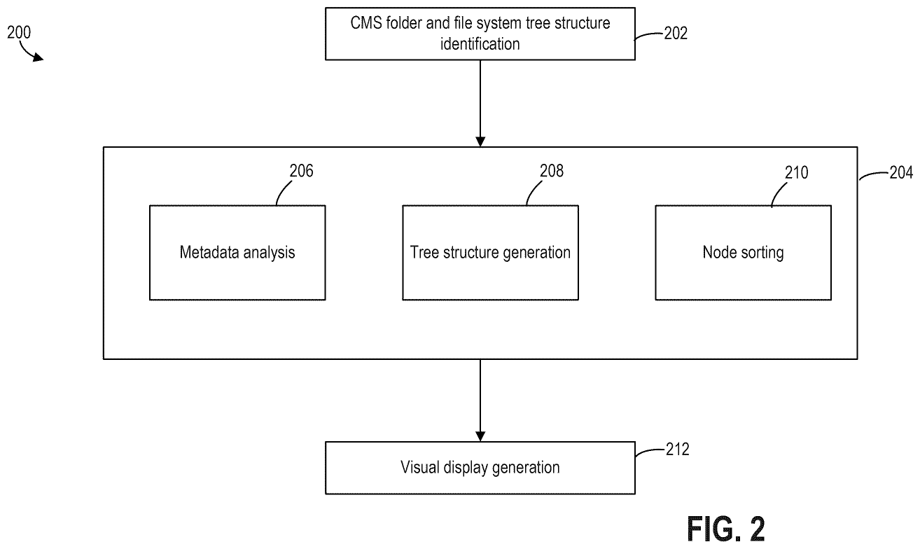

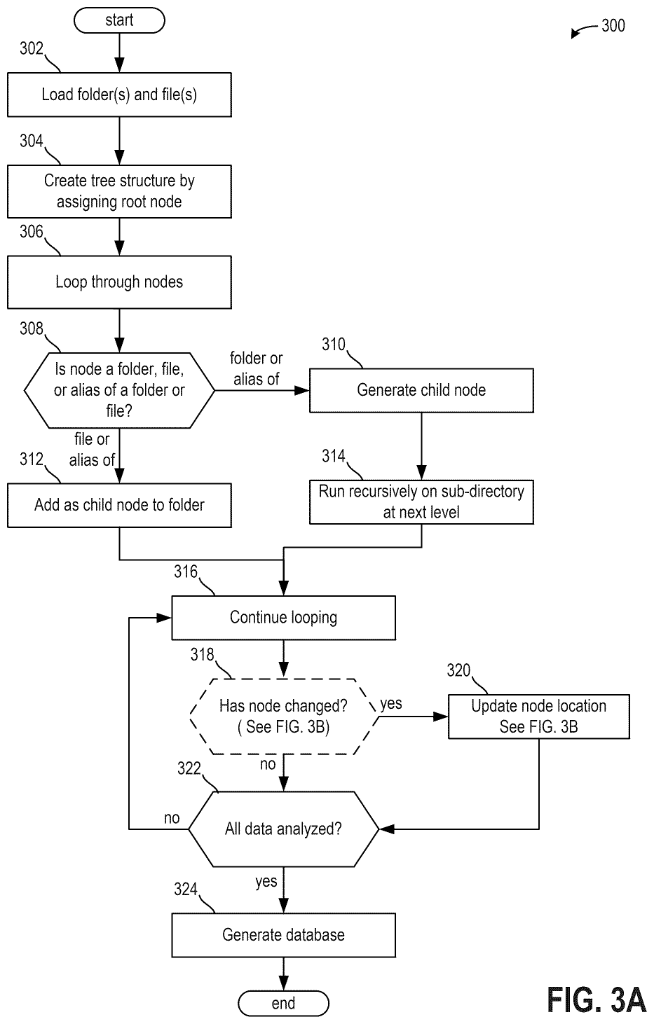

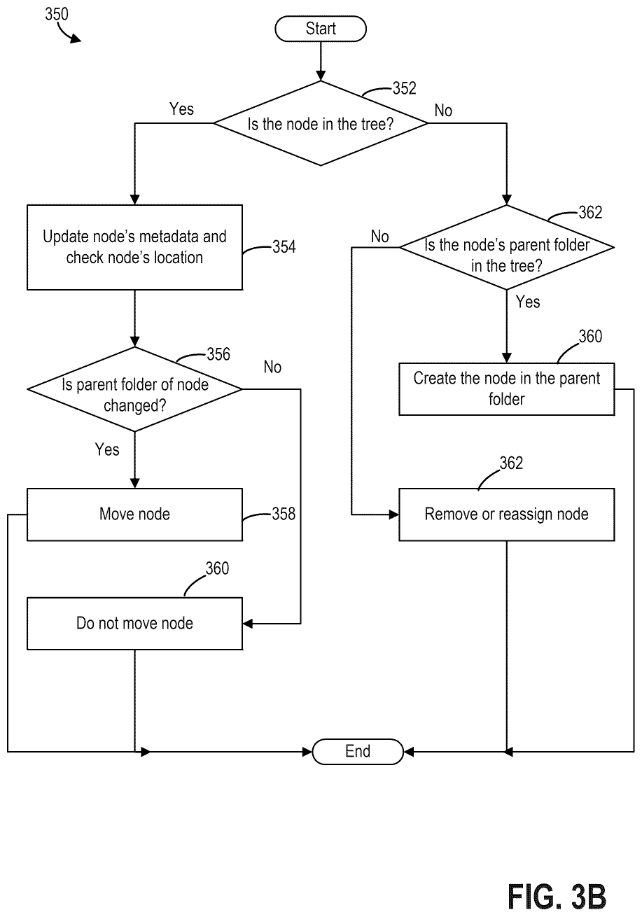

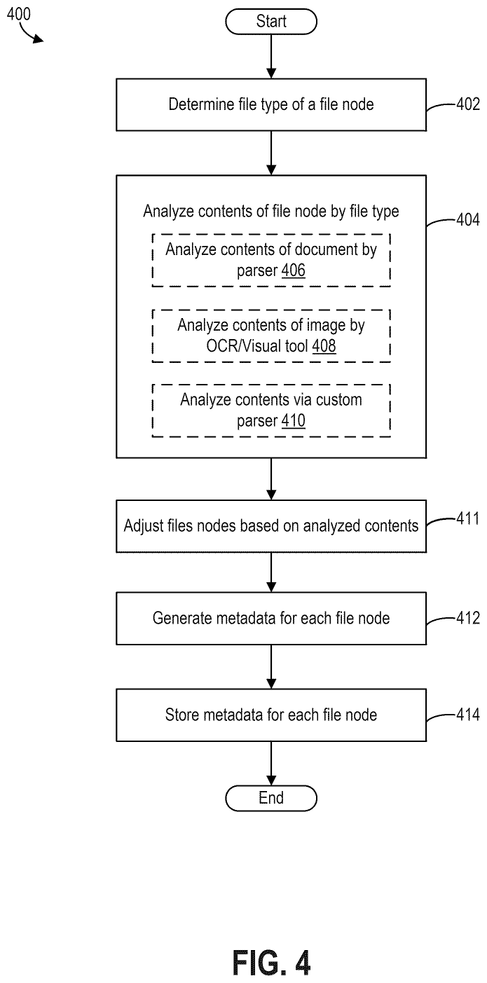

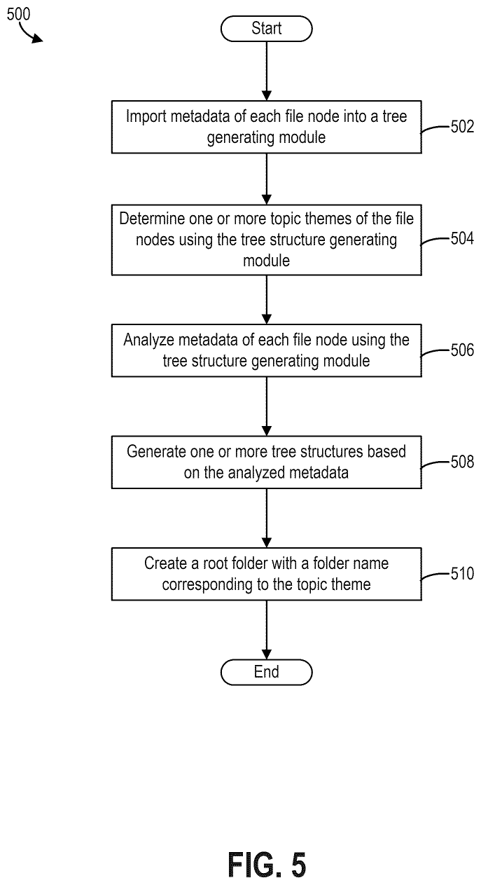

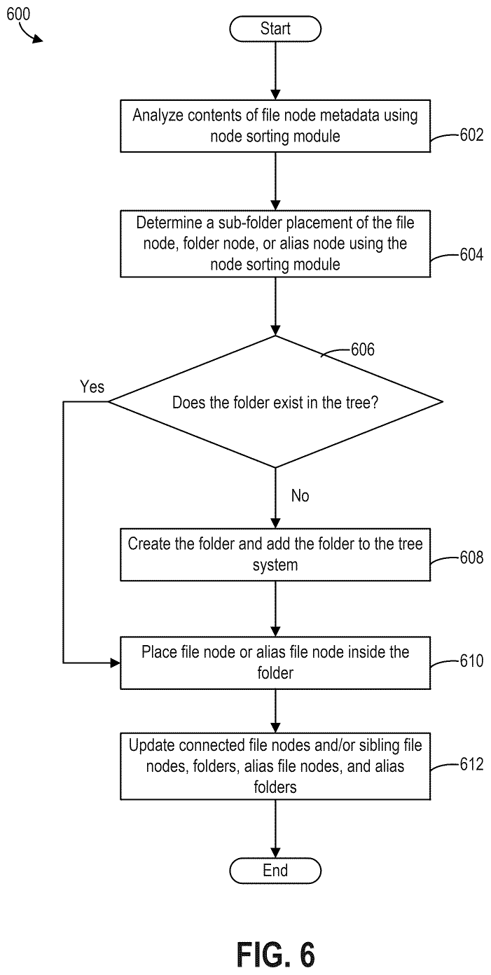

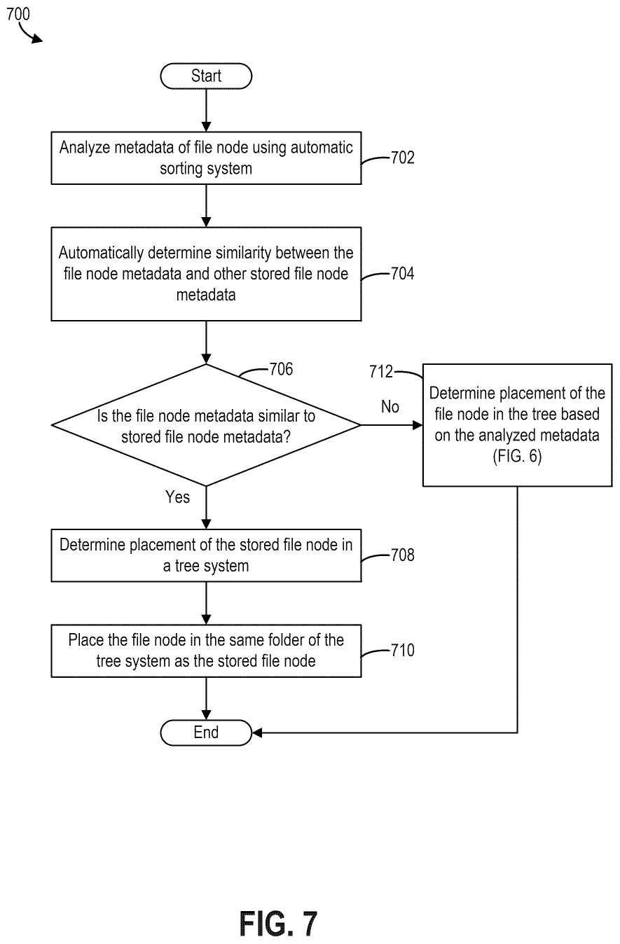

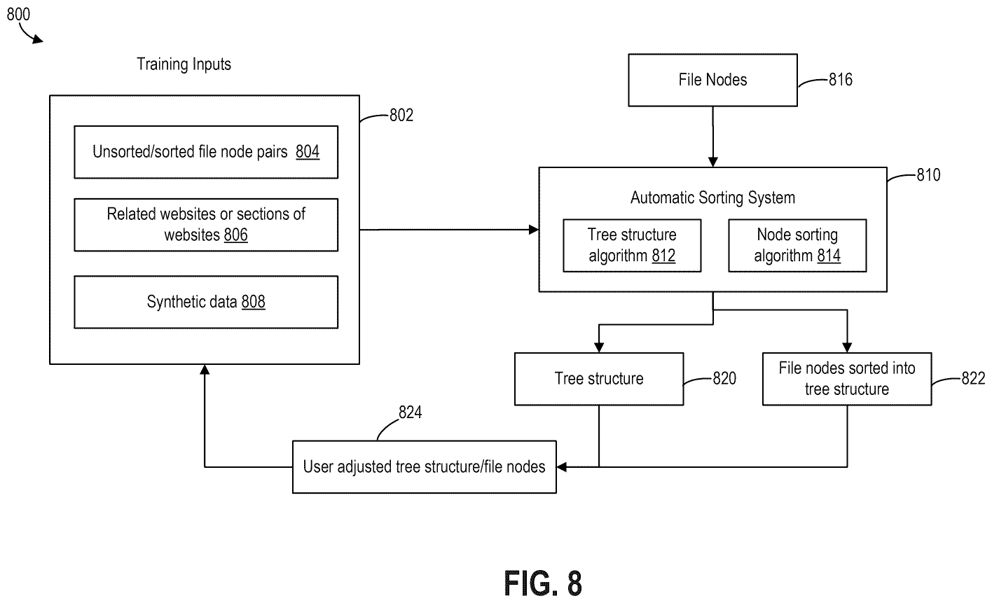

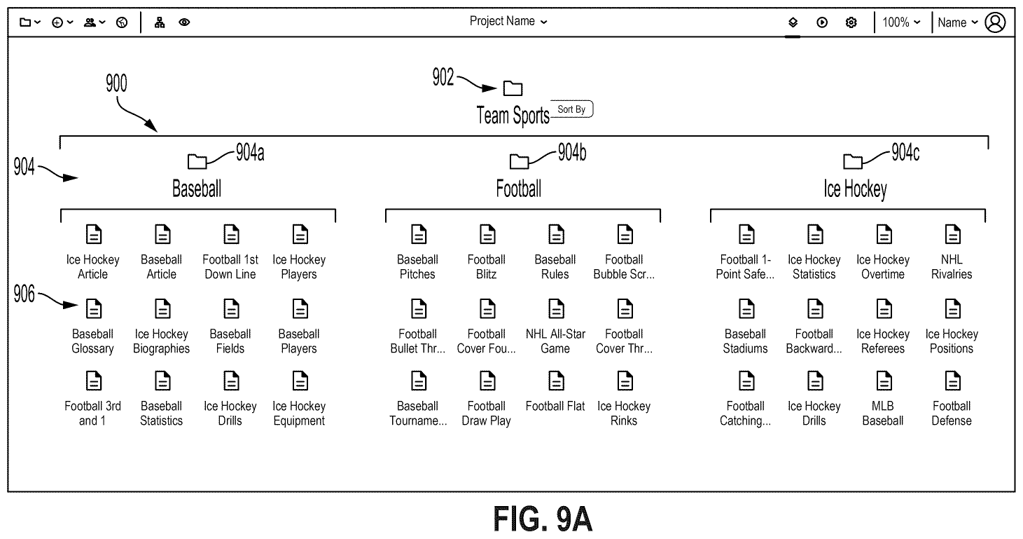

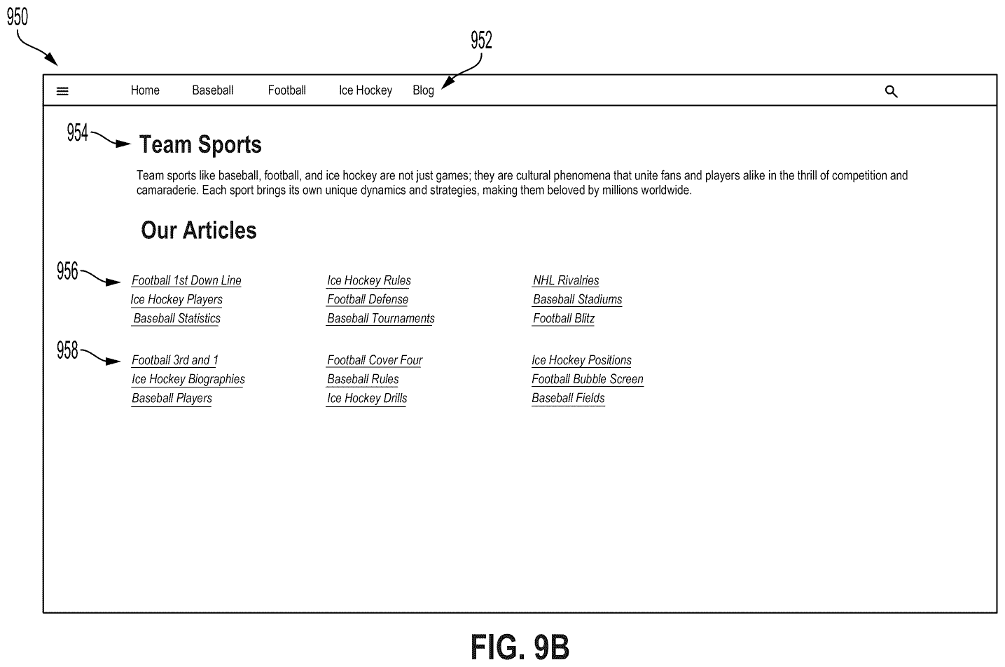

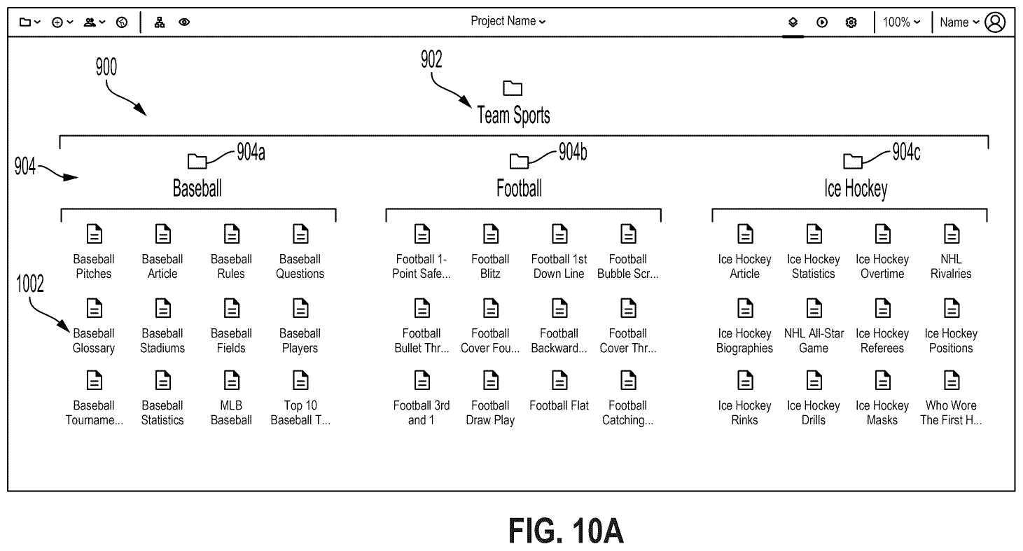

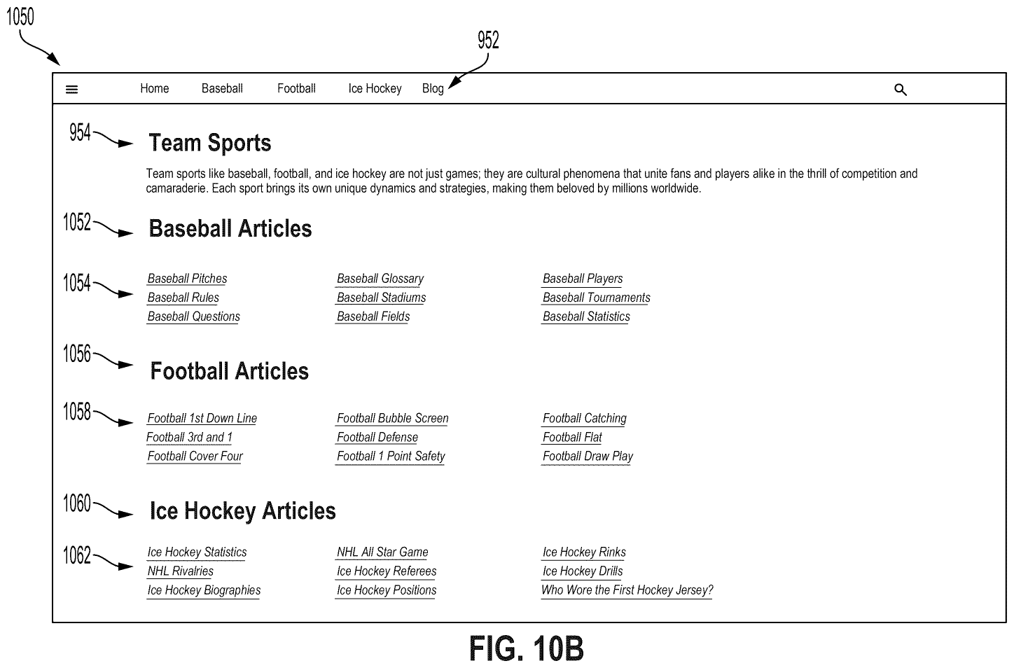

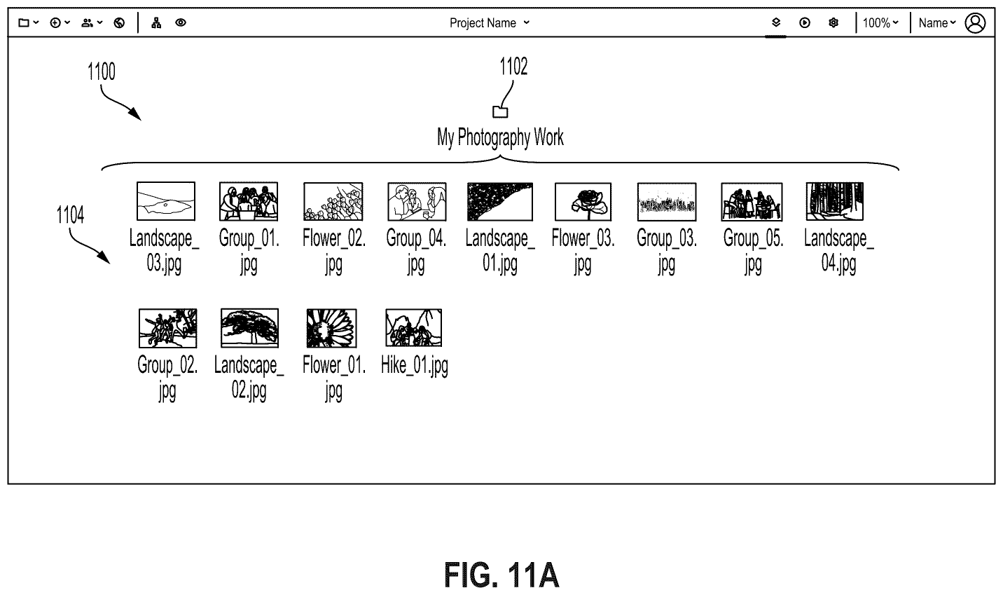

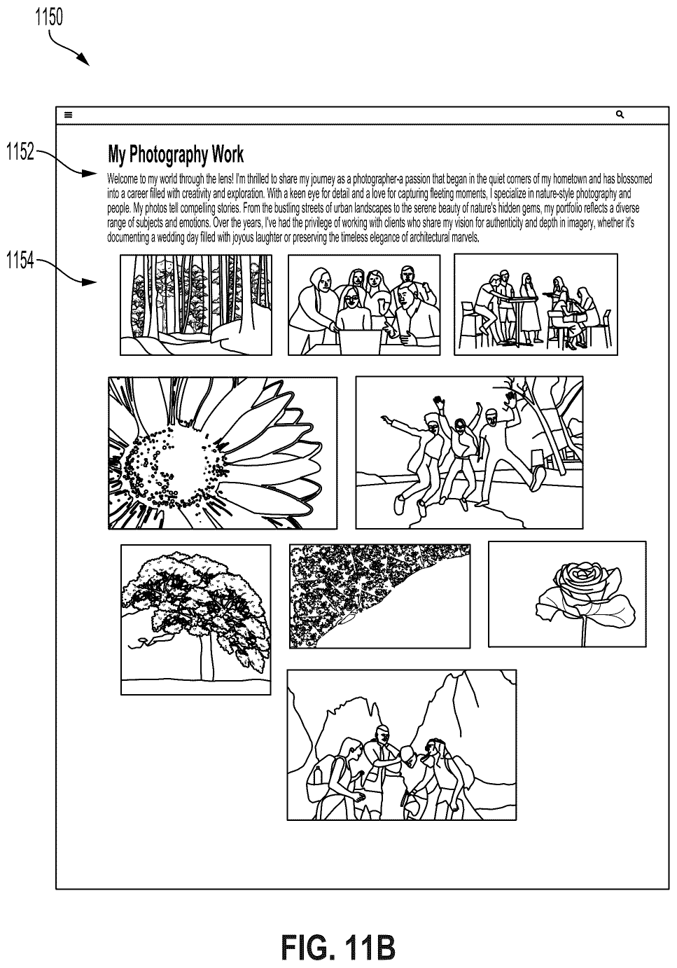

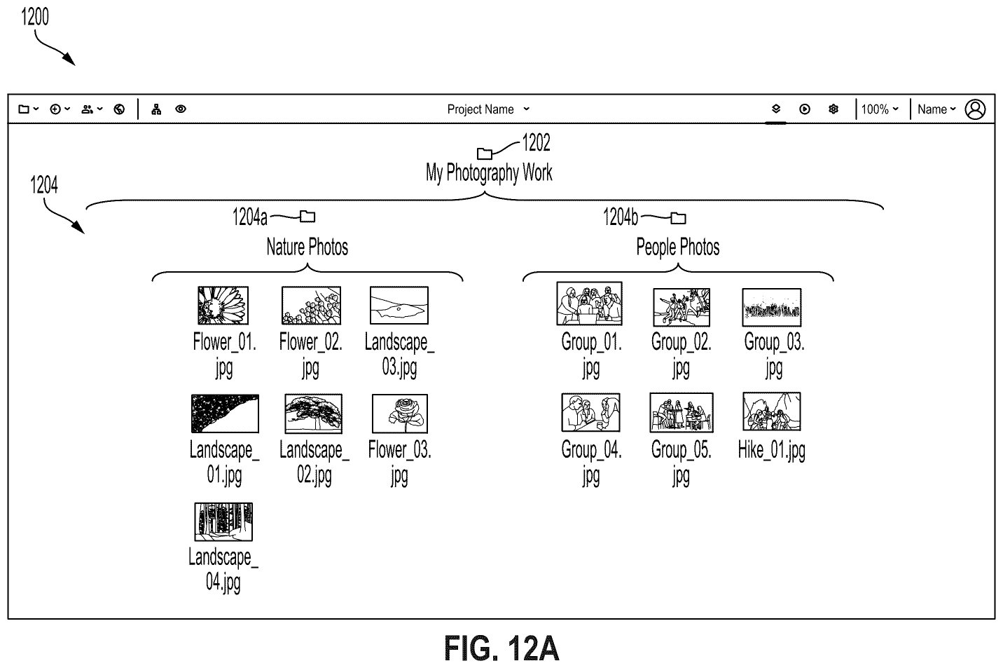

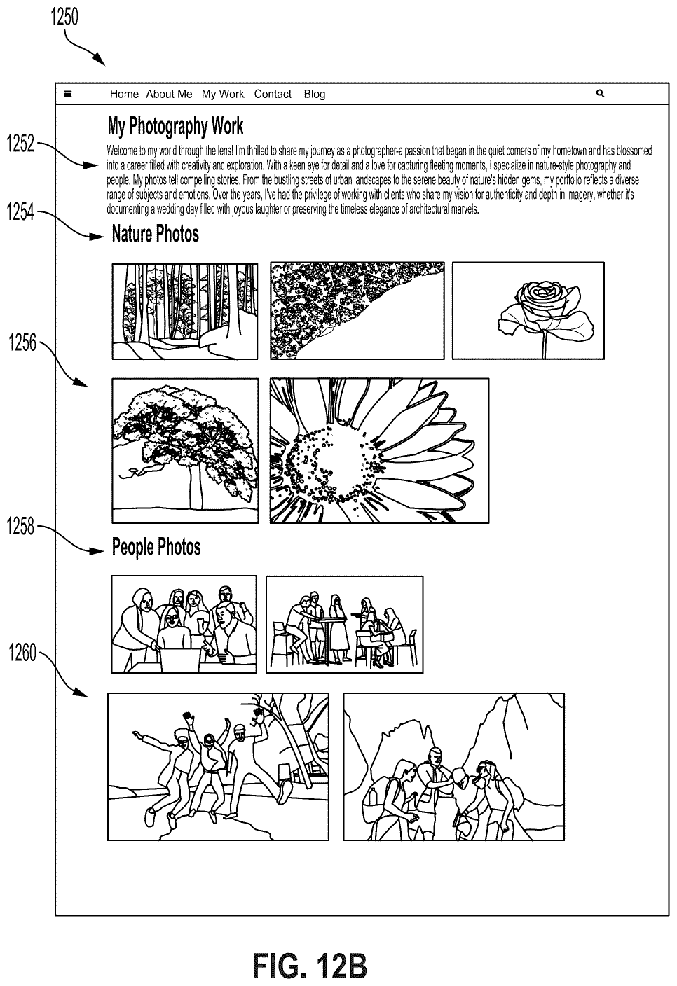

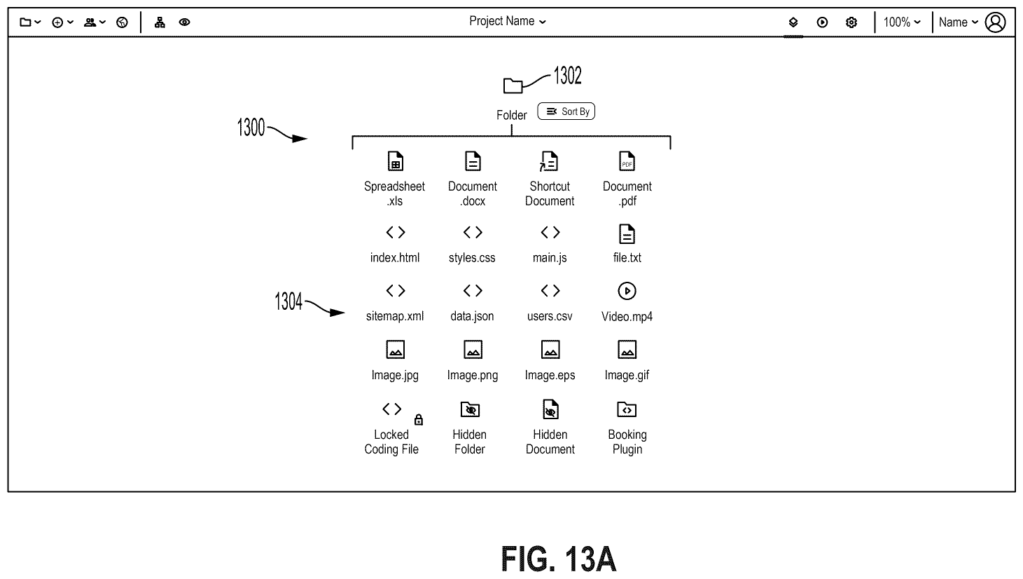

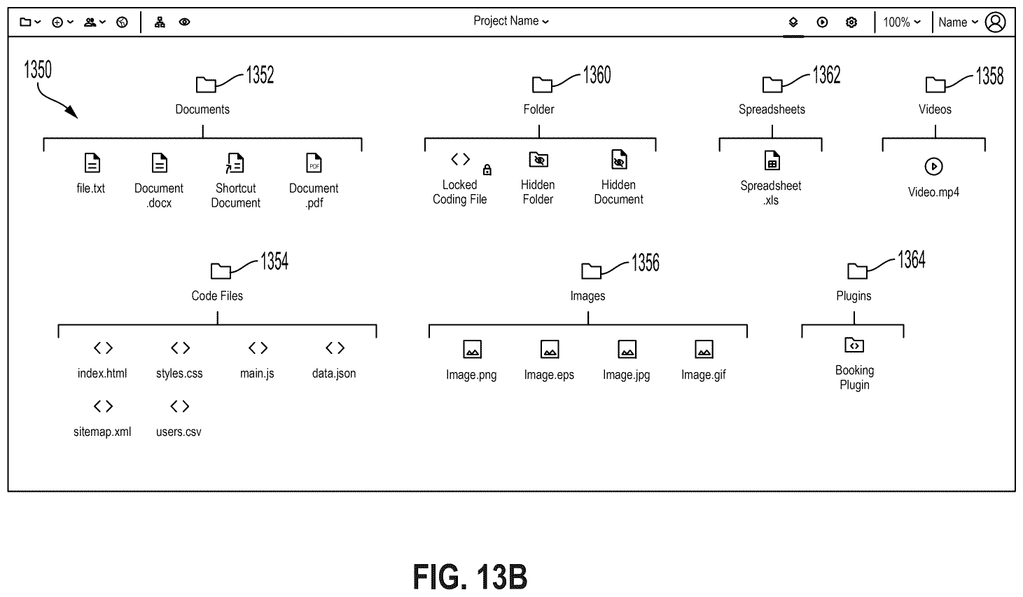

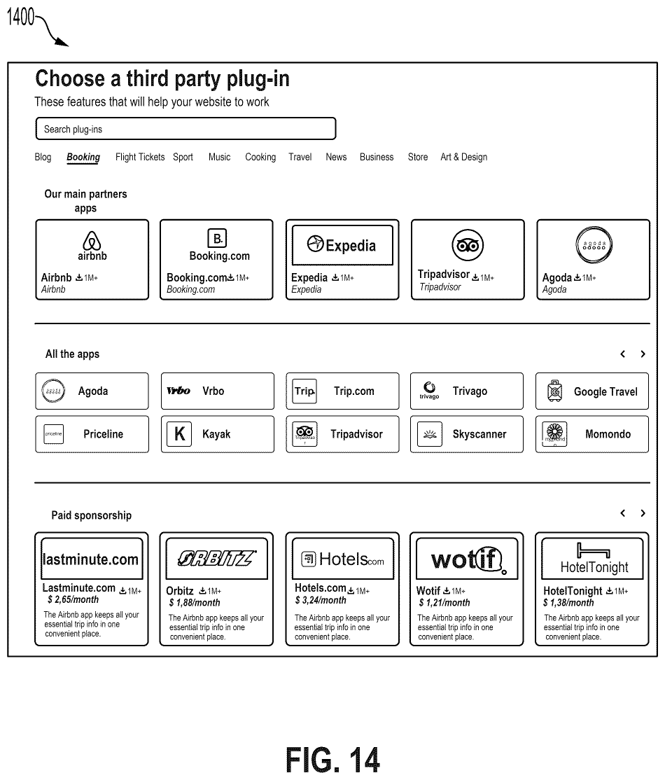

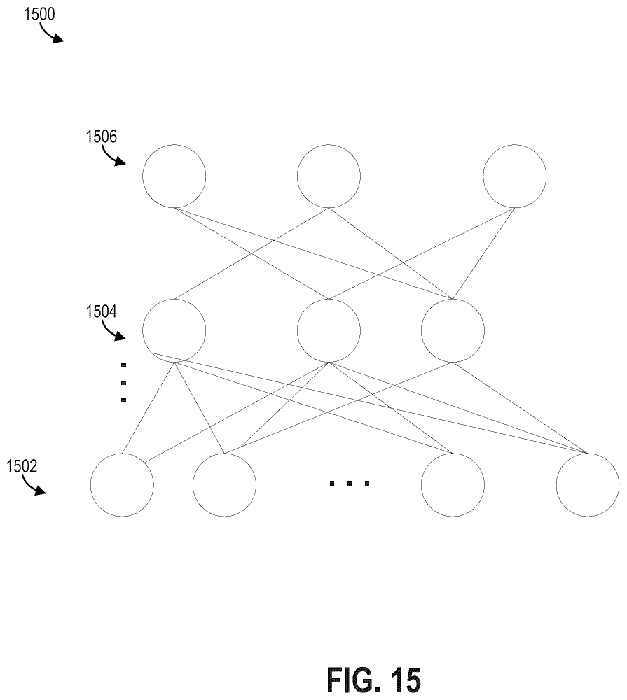

The CMS may be used locally, remotely, and/or may be cloud based. For example, the CMS may be a web based application. The automatic file sorting system may arrange content of the CMS into a tree structure. Herein, a tree structure refers to any relational data structure that may be produced, modified, or consumed by the automatic file sorting system. For example, the tree structure may be structured as a web, having a central node connected to many different child nodes. As a further example, the tree structure may be structured as a chain, having a starting node and each subsequent node connected to the previous. The tree structure may in turn correspond to an arrangement of content and webpages comprising a website. In this way, automatic sorting of content into folders may result in automatic placement of the sorted content onto the website. The automatic file sorting system may be included in a system for generating visually arranged and consumed content, such as a website or other outputs as described above based on the tree structure as shown in the block diagram of FIG. 2. A method for automatically generating the tree structure by analyzing content of a CMS is shown in FIGS. 3A-3B. Content of a website may comprise a plurality of file nodes. A method for automatically analyzing metadata of file nodes is shown in FIG. 4. The file nodes may include software application, such as third party software applications, as shown in FIG. 14. The analyzed metadata may be used to generate a tree structure for the file nodes as shown in the method of FIG. 5. The file nodes may then be sorted into the tree structure following the method of FIG. 6. In some examples, existing tree structures may be used to automatically sort the file nodes as shown in FIG. 7. In an exemplary embodiment, a large language model algorithm (LLM) or similar machine learning algorithm may be used in the automatic file sorting system. An example of a neural network which may be used in the automatic file sorting system is shown in FIG. 15. The machine learning algorithm may be trained and executed as shown in the block diagram of FIG. 8. An example of miss-sorted content of a folder system and a corresponding website is shown in FIGS. 9A and 9B while FIGS. 10A and 10B show an example of the folder system after automatic sorting and a corresponding website, respectively. FIGS. 11A and 11B compared to FIGS. 12A and 12B show examples of websites generated before (FIGS. 11A-B) and after (FIGS. 12A-B) re-generating a tree structure and automatically sorting file nodes. FIGS. 13A and 13B show examples of two different tree structures which may be automatically generated for different file types.

FIG. 1 is a block diagram illustrating an example networked computing system 100. The networked computing system 100 includes a server 101 and a plurality of client systems including at least one client system 121 communicatively coupled to the server 101 via a network 115. It may be appreciated that variations in the arrangement and type of components of the networked computing system 100 may be made without departing from the scope of the present disclosure. For example, the networked computing system 100 may include more than one client system 121 communicatively coupled to the server 101 via the network 115.

Server 101 comprises a computing system configured to serve web pages upon request to one or more client systems such as the client system 121. Although the server 101 is depicted in FIG. 1 as a single device, in some embodiments the networked computing system 100 may include a plurality of servers 101 configured for distributed computing. In different embodiments, the server 101 may take the form of a mainframe computer, a server computer, a desktop computer, a laptop computer, a tablet computer, a network computing device, a mobile computing device, a microprocessor, and so on.

Server 101 includes a logic subsystem 103 and a data-holding subsystem 104. Server 101 may optionally include a display subsystem 105, communication subsystem 106, and/or other components not shown in FIG. 1. For example, server 101 may also optionally include user input devices such as keyboards, mice, game controllers, cameras, microphones, and/or touch screen devices.

Logic subsystem 103 may include one or more physical devices configured to execute one or more instructions. For example, logic subsystem 103 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 103 may include one or more processors that are configured to execute software instructions. Additionally or alternatively, the logic subsystem 103 may include one or more hardware or firmware logic machines configured to execute hardware or firmware instructions. A processor or processors of the logic subsystem 103 may be single core or multi-core, and the programs executed thereon may be configured for parallel or distributed processing. The logic subsystem 103 may optionally include individual components that are distributed throughout two or more devices, which may be remotely located and/or configured for coordinated processing. One or more aspects of the logic subsystem 103 may be virtualized and executed by remotely accessible networked computing devices configured in a cloud computing configuration.

Data-holding subsystem 104 may include one or more physical, non-transitory devices configured to hold data and/or instructions executable by the logic subsystem 103 to implement the herein described methods and processes. When such methods and processes are implemented, the state of data-holding subsystem 104 may be transformed (for example, to hold different data).

In one example, the server 101 includes a web server for automatically generating a website. In another example, the server 101 includes a content server for providing assets such as images, videos, audio, and other types of files for embedding within web pages of a website rendered at a client system 121. In particular, as described further herein, a website generator tool 111 may evaluate code relating to files and folders metadata of a tree structure uploaded to the data-holding subsystem 104, generate one or more databases 112 based on the evaluated code, and automatically generate visually arranged and consumed content such as a website or other outputs as described above without further user input. Although the one or more databases 112 are depicted as stored in the data-holding subsystem 104 of the server 101, it should be appreciated that in some examples, the one or more databases 112 may be stored in a separate computing system communicatively coupled to the server 101 and accessible via the network 115. As an illustrative and non-limiting example, the one or more databases 112 may be stored on a separate content server (not shown) that further stores images and other content for a website.

Data-holding subsystem 104 may include removable media and/or built-in devices. Data-holding subsystem 104 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystem 104 may include devices with one or more of the following characteristics: volatile, nonvolatile, dynamic, static, read/write, read-only, random access, sequential access, location addressable, file addressable, and content addressable. In some embodiments, logic subsystem 103 and data-holding subsystem 104 may be integrated into one or more common devices, such as an application-specific integrated circuit or a system on a chip. One or more aspects of the data-holding subsystem 104 may be devices configured in a cloud computing configuration, in some examples.

It is to be appreciated that data-holding subsystem 104 includes one or more physical, non-transitory devices. In contrast, in some embodiments aspects of the instructions described herein may be propagated in a transitory fashion by a pure signal (for example, an electromagnetic signal) that is not held by a physical device for at least a finite duration. Furthermore, data and/or other forms of information pertaining to the present disclosure may be propagated by a pure signal.

When included, display subsystem 105 may be used to present a visual representation of data held by data-holding subsystem 104. As the herein described methods and processes change the data held by the data-holding subsystem 104, and thus transform the state of the data-holding subsystem 104, the state of display subsystem 105 may likewise be transformed to visually represent changes in the underlying data. Display subsystem 105 may include one or more display devices utilizing virtually any type of technology. Such display devices may be combined with logic subsystem 103 and/or data-holding subsystem 104 in a shared enclosure, or such display devices may be peripheral display devices.

When included, communication subsystem 106 may be configured to communicatively couple server 101 with one or more other computing devices, such as client system 121. Communication subsystem 106 may include wired and/or wireless communication devices compatible with one or more different communication protocols. As non-limiting examples, communication subsystem 106 may be configured for communication via a wireless telephone network, a wireless local area network, a wired local area network, a wireless wide area network, a wired wide area network, etc. In some embodiments, communication subsystem 106 may allow server 101 to send and/or receive messages to and/or from other devices via a network such as the public Internet. For example, communication subsystem 106 may communicatively couple server 101 with client system 121 via the network 115. In some examples, network 115 may be the public Internet. In other examples, network 115 may be regarded as a private network connection and may include, for example, a virtual private network or an encryption or other security mechanism employed over the public Internet.

Further, the server 101 provides a network service that is accessible to a plurality of users through a plurality of client systems such as the client system 121 communicatively coupled to the server 101 via the network 115. As such, the networked computing system 100 may include one or more devices operated by users, such as client system 121. Client system 121 may be any computing device configured to access a network such as network 115, including but not limited to a personal desktop computer, a laptop, a smartphone, a tablet, and the like. While one client system 121 is shown, it should be appreciated that any number of user devices or client systems may be communicatively coupled to the server 101 via the network 115.

Client system 121 includes a logic subsystem 123 and a data-holding subsystem 124. Client system 121 may optionally include a display subsystem 125, communication subsystem 126, a user interface subsystem 127, and/or other components not shown in FIG. 1.

Logic subsystem 123 may include one or more physical devices configured to execute one or more instructions. For example, logic subsystem 123 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 123 may include one or more processors that are configured to execute software instructions. Additionally or alternatively, the logic subsystem 123 may include one or more hardware or firmware logic machines configured to execute hardware or firmware instructions. Processors of the logic subsystem 123 may be single or multi-core, and the programs executed thereon may be configured for parallel or distributed processing. The logic subsystem 123 may optionally include individual components that are distributed throughout two or more devices, which may be remotely located and/or configured for coordinated processing. One or more aspects of the logic subsystem 123 may be virtualized and executed by remotely accessible networking computing devices configured in a cloud computing configuration.

Data-holding subsystem 124 may include one or more physical, non-transitory devices configured to hold data and/or instructions executable by the logic subsystem 123 to implement the herein described methods and processes. When such methods and processes are implemented, the state of data-holding subsystem 124 may be transformed (for example, to hold different data).

Data-holding subsystem 124 may include removable media and/or built-in devices. Data-holding subsystem 124 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystem 124 may include devices with one or more of the following characteristics: volatile, nonvolatile, dynamic, static, read/write, read-only, random access, sequential access, location addressable, file addressable, and content addressable. In some embodiments, logic subsystem 123 and data-holding subsystem 124 may be integrated into one or more common devices, such as an application-specific integrated circuit or a system on a chip.

When included, display subsystem 125 may be used to present a visual representation of data held by data-holding subsystem 124. As the herein described methods and processes change the data held by the data-holding subsystem 124, and thus transform the state of the data-holding subsystem 124, the state of display subsystem 125 may likewise be transformed to visually represent changes in the underlying data. Display subsystem 125 may include one or more display devices utilizing virtually any type of technology. Such display devices may be combined with logic subsystem 123 and/or data-holding subsystem 124 in a shared enclosure, or such display devices may be peripheral display devices.

In one example, the client system 121 may include executable instructions 131 in the data-holding subsystem 124 that, when executed by the logic subsystem 123, cause the logic subsystem 123 to perform various actions as described further herein. As one example, the client system 121 may be configured, via the instructions 131, to receive a web page including one or more images transmitted by the server 101, and display the web page including the one or more images via a graphical user interface on the display subsystem 125 to a user.

When included, communication subsystem 126 may be configured to communicatively couple client system 121 with one or more other computing devices, such as server 101. Communication subsystem 126 may include wired and/or wireless communication devices compatible with one or more different communication protocols. As non-limiting examples, communication subsystem 126 may be configured for communication via a wireless telephone network, a wireless local area network, a wired local area network, a wireless wide area network, a wired wide area network, etc. In some embodiments, communication subsystem 126 may allow client system 121 to send and/or receive messages to and/or from other devices, such as server 101, via a network 115 such as the public Internet.

Client system 121 may further include a user interface subsystem 127 comprising user input devices such as keyboards, mice, game controllers, cameras, microphones, and/or touch screens. A user of client system 121 may input a request to load or otherwise interact with a web page stored by the server 101, for example, via user interface subsystem 127.

Thus server 101 and client system 121 may each represent computing devices which may generally include any device that is configured to perform computation and that is capable of sending and receiving data communications by way of one or more wired and/or wireless communication interfaces. Such devices may be configured to communicate using any of a variety of network protocols. For example, client system 121 may be configured to execute a browser application stored as the instructions 131 that employs HTTP to request information from server 101 and then displays the retrieved information to a user on a display such as the display subsystem 125.

Turning now to FIG. 2, a block diagram 200 for an automated process for generating visually arranged and consumed content, such as a website or other output as described above from content stored on a CMS is shown. A tree structure of files and folders including content for a website stored in the CMS may be identified using tree structure identification module 202. Identifying a tree structure may include identifying a root folder and sub-folder nodes located within the root folder as well as file nodes stored in each of the sub-folder nodes. In some examples, the tree structure is a 3D structure with nodes connected in a plurality of directions. For example, a file node may be stored in a sub-folder node and may also be linked to a different sub-folder of the tree structure. An example of a method for identifying a tree structure is discussed further below with respect to FIGS. 3A-3B. Once the tree structure is identified, the file nodes stored within the tree structure may or may not be sorted accordingly. Herein, sorting file nodes refers to storing a file node in a folder corresponding to metadata of the file node.

After a tree structure is identified, file nodes may be automatically sorted by an automatic file sorting system 204. Automatic file sorting system 204 may include a metadata analysis module 206, tree structure generation module 208, and node sorting module 210. Metadata analysis module 206 may identify and store metadata for each file node as described further below with respect to the method of FIG. 4. In some examples, the CMS may include a plurality of folder nodes and no tree structure may be present. Alternatively, an existing tree structure may not include folder nodes corresponding to the analyzed metadata. In such examples, the tree structure generation module 208 may automatically generate one or more tree structures, each tree structure including a root folder. The method of tree structure generation using the tree structure generation module 208 is described further below with respect to the method of FIG. 5. The file nodes may then be sorted into the one or more tree structures by node sorting module 210. The method of sorting file nodes using the node sorting module is described further below with respect to the methods of FIGS. 6-7.

The tree structure including the sorted file nodes may then be input into a visual display generation module 212. Visual display generation module 212 may then position the content stored in the file nodes into visually arranged and consumed content (e.g., collection of information) to be output to a display subsystem. In some examples, the output may be a website and the visual display generation module 212 may generate a website. Placing of the content on webpages of the website may be determined based on the folder into which the corresponding file node is sorted. Placing the content on webpages may include placing sections and/or widgets of webpages. In this way, automatic sorting of file nodes may result in an organized website. In other examples, the output may be a mobile application and placing of visual components of the mobile application such as, but not limited to, menus, widgets, text description, pictures may be determined based on the tree structure. The tree structure may determine an appearance of the user interface of the mobile application. In this way, the automatic sorting of file nodes may result in an organized mobile application.

Automatic sorting of file nodes may make generating some features of websites more computationally efficient than simply a collection of tagged files. By having the file nodes automatically sorted into the tree structure, which is logical and patterned, the algorithms for generating website structures may easily and efficiently identify the patterns and related website structures. For example, placing a breadcrumb of a webpage may refer to the folder location of the file nodes of the webpage. As an additional example, generating a collection page related to one topic may use content from all file nodes within a selected folder. As a further example, a sidebar may be generated from a folder or alias files where the files are located in multiple locations in a tree structure. Without the tree structure and alias folders, such a query may be computationally inefficient or may not return all desired results. By including alias files in a folder, the sidebar may be generated by a simple query. The patterns provided by the tree structure and alias folders demand less complicated algorithms for searching and generating components of content, such as website. For example, the user commands for generating the sidebar may be to select all files in folder and display their links in a sidebar to a viewer.

In further examples, visual display generation module 212 may be an API configured to output the tree structure content to be visually arranged and consumed, such as a website, using a language such as JSON or XML. For example, the JSON or XML may represent the tree structure as data instead of a website. A user may input the data to a software development kit for a desired programming language. The user may then, using the desired programming language, query the tree structure data and render the tree structure. The user may render a sub-structure (e.g., folders at a desired depth) of the tree structure as a widget. In an alternate example, the user may request all files updated on a certain date as a bulleted list or other requested visual rendering. In this way, the tree structure may be used as headless CMS. Additionally or alternatively, the user may use an API to connect the tree structure to a software application. In such an example, the tree structure may act as a database exposed as an API and the API may transform the data of the tree structure to serve as a database or backend of the software application. In a further example, the API may be automatically constructed based on the tree structure and its contents based on how the user plans on exposing the contents. In some examples, an artificial learning algorithm may be used to automatically generate the API.

Turning now to FIG. 3A, a method 300 for reading a file system, such as a file system stored in a CMS and generating a tree structure of the content management system is shown. The tree structure may be based on a plurality of assets retrieved from a client system and/or a website. In one example, the tree structure may be generated for a mirrored file structure stored in the CMS. In this way, organization of original files and folders is not changed. The method 300 and the rest of the methods herein may be executed via instructions stored on non-transitory memory of the logic subsystem 103 of FIG. 1 that, when executed, enable processors of the logic subsystem to analyze assets and read metadata thereof.

The method 300 begins at 302, which includes loading the one or more folders and files. Loading the one or more folders and files may include retrieving the one or more folders and files from the data-holding subsystem. In one example, the one or more folders and files loaded may be marked or otherwise indicated by the client to be used for outputting a website. In some examples, the folder and files may be loaded via a link and/or by drag and drop of the folder and files into a user interface. Additionally or alternatively, a website's server may be scraped for the folders and files comprising the website. In some examples, the one or more folders and files may be loaded from different sources (e.g., two different websites, subdomains, servers, databases, a website and/or an additional collection of files) to be combined into a single tree structure. For example, file system A and another file system B may live in two different places and method 300 may combine file system A and file system B into a single tree structure.

The method 300 may proceed to 304 to create a tree structure which may be performed by tools of the folder-based content management system. Creating the tree structure from the one or more folders and files may include identifying and assigning a root node, which may be determined by analysis of the metadata. In some examples the tree structure may be created for a specified depth of the file system (e.g., a sub-tree). For example, the tree structure may be created for the root node (depth 0), the node directly related to the root node (depth 1), but not to nodes directly connected to depth 1 (depth 2). Creating the tree structure only to a specified depth may allow for increased processing efficiency of the method. By demanding the tree structure to a specific depth, processing power may be allocated according to an amount of granularity for the desired output. Otherwise, additional processing power may be spent on further creating a tree structure with more depth than what is desired for the related visually consumed output. In this way, the created tree structure may be generated more efficiently than if the depth was not specified.

The metadata may include data regarding a branching of the asset, thereby indicating if an asset is a root, a parent, or a child asset. Identification of the asset types may indicate whether or not the file system has an organizational structure that may allow files and sub-folders to be defined as parent and/or child nodes under the root node. In some examples, creating the tree structure may include resynchronizing parts of a tree structure. For example, a specified node or nodes may be resynchronized to a specified depth. By allowing for selective resynchronizing instead of an entire tree structure, a speed and computational efficiency of the algorithm may be increased. The computational power may be used for resynchronizing parts of the tree structure that demand resynchronization, and not for parts of the tree structure that stay the same. In this way, the method is more computationally efficient than if the entire tree structure is resynchronized with each update of the CMS. For example, the method may include determining if a root node is generated first and then seeing if the parent node is generated in the tree. In one example, the parent node is generated to further assist in organization of file components. In one example, generating a parent node may include classifying the node as a parent node and branching all future nodes therefrom.

At 306, the method includes evaluating and looping through the one or more folders and files, e.g., nodes. The evaluating and looping may include further analysis of the metadata of the nodes. At 308, the method includes confirming if a selected node of the one or more folders and files is a folder (e.g., a branch), a file, or an alias of a folder or file. Herein, an alias refers to a file or folder that is not unique content but is a shortcut to a unique file or folder. An alias folder or file may not be an alias to itself or to a folder in which the alias folder is placed.

If the node is a folder or alias of a folder, the method proceeds to 310 to generate a child node from the selected node. At 314, the method includes analyzing nodes recursively on a sub-directory at a subsequent, e.g., next, level of the tree structure. The method continues to 316 to continue looping through the nodes of the tree structure.

Returning to 308, if the selected node is a file or alias of a file, the selected node is added at 312 as a child node to a folder in which the file is located. The method proceeds to 316 to continue looping through the nodes of the tree structure. In some examples, the loop may skip file nodes, folder nodes, alias files or alias folders that are already included in the tree structure. At 318, the method optionally includes confirming if a node of the tree structure changed for the file system. Confirming if a node of the tree structure changed for the file system may increase a computational efficiency of generating the tree structure and may be used for very large files systems. As the size of a file systems increases, updating node locations for nodes that have not changed may be a drain on processing power. In this way, the processing power demanded for generating the tree structure is minimized as the updating of node locations may proceed in response to a change in the node and may not occur if there is no change in the node.

If, at 318, the node has changed for the file system, the method proceeds to 320 to update the location of, e.g., resynchronize, the node. Turning now to FIG. 3B a method 350 is shown, describing in greater detail a method for determining if a node has changed and updating the node. Method 350 may be applied to file nodes, folder nodes, and alias files and folders. Method 350 may be repeated once per file node. For a folder node, method 350 may be repeated recursively for all nodes inside the folder. For an alias file, the method 350 may be repeated twice, once for the alias file node and again for the target node that the alias file refers to. At 352, method 350 includes determining if the node being analyzed is in the tree structure. For example, a node in the tree structure may include metadata associating the node with parent and/or sibling nodes. If at 352, method 350 determines that the node is in the tree structure, method 350 proceeds to 354 and includes updating the node's metadata and checking the node's location. Checking the nodes location may include determining the associated parent and/or sibling nodes of the node.

At 356, method 350 determines if the parent folder of the node is changed. The parent folder of the node may be changed if the metadata of the node does not match its location within the tree structure. If method 350 determines the parent folder of the node is changed, method 350 proceeds to 358 and moves the node. Moving the node may include moving the node so that the parent folder of the node's location matches the parent folder of the node's metadata. Method 350 ends. If at 356, method 350 determines that the parent folder is not changed, method 350 proceeds to 360 and does not move the node. Method 350 ends.

If at 352, method 350 determines that the node is not in the tree structure, method 350 proceeds to 362 and the method then determines if the node's parent folder is in the tree structure. If the node's parent folder is in the tree structure, method 350 proceeds to 360 and includes creating the node in the parent folder. Method 350 ends. If the method determines that the node's parent folder is not in the tree structure, method 350 proceeds to 362 and includes removing or reassigning the node to a different parent folder. In this way, each node is resynchronized to be included in the tree structure and associated with a parent folder according to the node metadata. As one example, the parent node may change location which may result in the re-assignment of all previously existing child nodes to a new parent node. Additionally, if a child node is moved as a result of change in the parent node, the method may update each node connected to the child node. For example, sibling nodes or further connected child nodes may also be updated. If the parent node no longer exists, all child nodes may be deleted or reassigned to closest related folder nodes.

Returning now to method 300 shown in FIG. 3A, if at 318, the parent node has not changed for the node to be re-synced, the method continues to 322 to confirm if all the metadata of the tree structure has been analyzed. For example, all data may be analyzed if all folders and files and their metadata are evaluated and categorized. If all data is not analyzed, then the method returns to 316 to continue looping through the tree structure. This may allow all the metadata to be analyzed and organized according to parent node and child node relationships included in the metadata. If, at 322, all the metadata is analyzed, then the method proceeds to 324 to generate a database.

In some examples, the method 300 may be used to build a sub-tree of a larger tree. In this case, a different “root” node may be specified and the process of looping through its child nodes remains the same to build the tree. With larger websites, the process may be time-consuming, so parts of the tree to be changed or having direct dependencies upon other parts may be updated. If a node is updated, it may affect other nodes, parents, siblings, children, etc. In instances where the website is a dynamic website or a client-rendered site is in JavaScript, for example, the full tree or sub-trees may be rendered in real-time or consumed as an API for use in applications such as real-time JavaScript.

Once the tree structure is identified the file nodes may not be sorted in accordance with the tree structure. In some examples, the file nodes may be sorted but a user may demand a different tree structure. Additionally or alternatively, the tree structure may be reset and resorted based on a manual adjustment of a node of by the user. For example, a user may delete a node, add a new node or move a sub-node to a different parent node. In some examples, the adjustment of nodes including: addition, movement, and/or deletion of some nodes may be automatic or a combination of manual and automatic. In some examples, automatic adjustment may be made by a rules based algorithm. The rules based algorithm may be weighted by the user to prioritize desired features of the tree structure. In alternate examples, the automatic adjustment of nodes may be performed by an artificial intelligence and/or machine learning algorithm (AI/ML). The AI/ML algorithm may be configured to learn preferred node adjustments from previous manual adjustments made by the user. In some examples, a combination of a rules based algorithm and AI/ML algorithm may be used. Additionally or alternatively, a user may manually adjust nodes during a training period to train the AI/ML algorithm and after the training period, the adjustment of nodes may be done automatically by the AI/ML algorithm.

Herein a machine learning algorithm is considered a type of artificial intelligence algorithm. Machine learning algorithms may include deep learning algorithms. Deep learning algorithms may include artificial neural networks, convolutional neural networks, and/or recurrent neural networks. Machine learning algorithms may also include natural language processing and large language models. An example of a neural network 1500 which may be used in one or more of the AI/ML processes described herein is shown in FIG. 15. Neural network 1500 may include an input layer 1502 including a plurality of neurons. Neurons of the input layer may be, for example, pixels of an image, letters of text, or a representation of a tree structure. The input layer may be connected to one or more hidden layers 1504 of neural network 1500. The hidden layers may each include one or more neurons. Hidden layer 1504 may be connected to an output layer 1506. Output layer 1506 may also include one or more neurons. Neurons of the output layer may correspond, for example, to contents of an image, topic of a text, or adjusted connections of a tree structure. Weights of connections between the neurons may be learned through training of the neural network as discussed herein.

In alternate examples, the file nodes may be resorted in response to new content being added to the server in the form of new file nods. The automatic file sorting system may adapt the one or more tree structures in real-time to include the new file nodes. In this way the resulting visually consumed content may be likewise adjusted in response to the new file nodes as a background process that occurs automatically without input from the user.

The automatic file sorting system may sort the file nodes within a tree structure. The automatic file sorting system may include a metadata analysis module configured to generate and store metadata of each file node. Method 400 shown in FIG. 4 is an example of a method for generating and storing metadata using the metadata analysis module of the automatic file sorting system.

At 402, method 400 includes determining a file type of each file node to be sorted. In some examples, each file node may be stored within the tree structure. In alternate examples, the file nodes may be input to the automatic file sorting system without an associated tree structure. As a non-limiting example, file node types may be one or more of text, alias files, coding files, image, data, and video files, among others. Determining the file type may include determining an extension of the file node and assigning a corresponding type. As one example, the corresponding type may be stored in a look-up table. For examples files ending in .png, .jpeg, or .pdf may be assigned an image type. As another example, files ending in .html, .css, .js, .json, or .xml may be assigned as coding files.

As a further example, a node may be a software application (e.g., a plugin or widget). In such example, the node may represent a collection of many files and folders comprising the software application. In some examples the node represents a compressed collection of files and/or folders (e.g., a .zip folder) comprising the software application. In this way, software applications used in visually generated and consumed content may also be automatically sorted and positioned as demanded. In some examples, the software applications may be provided by a third party. For example, a tree structure for generating a website of a hotel may include an AirBnb™ booking application file node. Turning briefly to FIG. 14, a page 1400 is shown. Page 1400 may be a non-limiting example of a listing of third party software applications a user may select from to be included as file nodes in a tree structure.

Returning now to FIG. 4, At 404, method 400 includes analyzing contents of the file node by type. Analyzing contents of the file node by type may include identifying keywords associated with the contents of the file node. In some examples, the analyzed contents of the file node may be descriptive metadata of the file node. Analyzing contents of the file node may occur automatically in response to file nodes being input to the automatic sorting system without any further input or commands from the user. In some examples, analyzing contents of the file type may include extracting the content included in each file node as text that may be stored as metadata associated with the file node. In some examples, analyzing the contents of the file node may include analyzing the contents of documents by a parser at 406. In alternate examples, analyzing the contents of file nodes may include analyzing contents of images and/or videos by optical character recognition or another computer vision tool configured to output a textual description of a graphical input at 408. In further examples, analyzing the contents of the file node may include analyzing contents of the file node via a custom parser at 410. The custom parser may be configured to output textual descriptions specifically for a file type such as, but not limited to .json, .css, .html, .mp4, .mp3, .tiff, or .txt.

At 411, method 400 includes adjusting file nodes based on the analyzed contents. The adjustments may increase an efficiency or usability of the tree structure including the file nodes. For example, adjusting may include splitting up a coding file node (e.g., .html, .css., .js) to make the code more efficient. In further examples, adjusting may include splitting up a text node into multiple documents which are more logically and easily consumed by a viewer. Splitting up text nodes in this way may allow for the text then be visually divided when the website is generated. When visually consumed, the divided text may be more logical and easily understood by a viewer of the website. Moreover, text may be divided and positioned on the website so that context to the text is provided and the user is able to comprehend the meaning of the text.

In further examples, adjusting may include downloading an image that is linked to in a file node but not stored locally. In this way, adjusting may optimize performance of the visually generated and consumed content. In some examples, adjusting file nodes may include automatically adjusting the file nodes. In alternate examples, adjusting file nodes may include presenting the adjustments to a user as suggestions which a user may accept or chose not to adjust the files.

At 412, method 400 includes generating metadata for each file node to be stored along with the contents analyzed at 404 (e.g., the descriptive metadata). The metadata may be generated by the method, and may be therefore referred to as synthetic metadata. The generated data may include one or more of additional descriptive metadata, structural metadata and administrative metadata. Additional descriptive metadata may include but is not limited to: a file name, a file description, a file type, a file size, titles, created dates, modified dates, modified times. Structural metadata may include but is not limited to: a depth of the file node in the tree, a link to view the file, and a local or remote path to the file. Administrative metadata may include editing permissions and digital use rights. In some examples, additional metadata, such as additional tags, may be provided by the user. At 414, method 400 includes storing the metadata for each file node. The stored metadata including contents analyzed at step 404 and the additional metadata generated at step 412. Method 400 ends.

Once the metadata of the file nodes is generated as described above with respect to FIG. 4. A tree structure may be generated based on selected metadata of each of the file nodes. For example, the selected metadata for generating the tree structure may include the content metadata generated at step 404. In some examples, if the tree structure is already generated, tree structure metadata, such as sibling nodes, child nodes, and parent nodes, may be selected metadata for generating a new tree structure. In alternate examples, the selected metadata may depend on the output of the tree structure. For example, metadata such as file name, description, and created date may be selected if the tree structure is to output a website. In some examples, the tree structure identified based on the files and folders as described above with respect to FIGS. 3A-3B may be modified by the tree structure generating module by first consuming a predefined tree structure via one or more of an API in a JSON or XML format, an HTTP protocol by crawling a server specified by the user, and a direct upload. In alternate examples, a user may instruct the automatic sorting system to skip generating the tree structure and sort the file nodes based on the identified tree structure. Automatically sorting after a tree structure is generated may increase computing efficiency of both the tree generating and automatic sorting methods. For example, as additional nodes in a tree structure are generated, previous sorting may demand updating, leading to a more computationally complex method.

At 502, method 500 includes importing metadata of each file node into a tree generating module. The data may be imported from where the metadata was stored at the conclusion of method 400. In some examples the tree generating module may include a machine learning algorithm. In further examples, the machine learning algorithm may be a large language model algorithm (LLM). The large language model and/or other machine learning algorithms may ingest the metadata of each file node, including the analyzed content describing, in text, the information conveyed by the file node. For example, the analyzed content metadata and additional metadata may be tokens input into the LLM. The machine learning algorithm and/or LLM may be able to holistically consider topics of each of the file nodes of the CMS. In other examples, the machine learning algorithm ingesting the metadata may be a neural network, such as a convolutional neural network. In some examples a combination of machine learning algorithms may be used. For example, a LLM may ingest text based file nodes and a convolutional neural network may ingest the image based file nodes.

At 504, method 500 includes determining one or more topic themes of the file nodes using the tree generating module. In some examples, the tree generating module may automatically determine the one or more topic themes of the file nodes in response to file nodes being imported into the automatic file sorting system without a tree structure. In alternate examples, a user may request that the automatic sorting system determine the one or more topic themes of the file nodes. The one or more topic themes may be determined by the LLM and/or another machine learning algorithm such as a neural network. In some examples, the algorithm including the LLM or other machine learning algorithm may weight one or more of the metadata of the file nodes to determine the topic theme. In examples where the machine learning algorithm is a neural network, the weights may be learned by training the neural network. For example, weights may emphasize and/or deemphasize a type of metadata when determining the topic theme. In some examples, a user may provide a ranking of metadata (e.g., most important to least important) which is translated by the algorithm to a weight. The weights may be updated in response to updates to the metadata and/or as additional file nodes are imported into the automatic sorting system. For example, the subject of the file nodes, the amount of data in each file node, along with other factors may change, resulting in automatic updates to the weights. In alternate examples, a user may specify one or more topic themes and the tree generating module may then determine if the one or more topic themes encompass the analyzed file nodes. In some examples, the tree generating module may update weights of the algorithm based on the requested topic theme. For example, the machine learning algorithm may weight topics by the count of number of nodes that are about the topic. In some examples, the weight may be adjusted by the user. For example, the user may request a topic theme where the most recently modified file nodes are weighted the highest. As a further example, the user may request a topic theme where file nodes with high engagement metrics or a specific file type are weighted higher.

In examples where the tree generating module determines where a user suggested topic theme does not encompass the analyzed file nodes, the tree generating module may suggest a different topic theme or themes. In examples where the algorithm is an LLM, the user may adjust the weight using a natural language user command that is understood and translated to algorithm weights by the LLM. For example, instead of using html code or a SQL database query, a user may type “organize files according to date generated”. In some examples the one or more topic themes may be topic themes of a website or section of a website to be generated based on the tree structure and the automatically sorted file nodes.

At 506, method 500 includes analyzing metadata of each file node using the tree generating module. Analyzing the metadata may include analyzing the metadata using the LLM and/or machine learning algorithm. For example, analyzing the metadata may include analyzing the metadata corresponding to the analyzed contents of each file node. Analyzing the metadata may further include analyzing the additional generated metadata of the file node such as file size, file type, date created, among others.

At 508, method 500 includes generating one or more tree structures based on the analyzed metadata. The one or more tree structures may each include a root folder and one or more sub-folders. The one or more tree structures may be generated by the LLM and/or other algorithms. In some examples, a tree structure may be generated for each output. For example, a first tree structure may be generated for outputting a website from the file nodes and a second tree structure may be generated for outputting a mobile application from the file nodes. Further, the one or more tree structures may be generated automatically by the tree generating module without any instructions or input by the user. Generating the one or more tree structures may include generating a map of each of the one or more topic themes and identifying sub-topics that are related to the one or more topic themes and correspond to metadata of one or more of the file nodes.

In examples where a sub-topic applies to more than one topic theme (e.g., is in more than one tree structure), an alias folder may be generated for the sub-topic. In this way, the sub-topic may be in more than one tree structure, but memory use is more efficient because an alias is used instead of duplicating the data of the folder. As one example, the sub-topics may be generated based on the LLM's understanding of contents of the file node based on the metadata. As a further example, the LLM and/or other algorithm may identify a topic or topics describing contents of the file node to become the sub-topics (e.g., parent folder nodes or child folder nodes) of the one or more tree structures. In alternate examples, generating the one or more tree structures may be based on user modifications to the visually arranged and consumed content output based on the tree structure. In some examples, the user modifications may be input as a natural language command and interpreted by the LLM to update the tree structure. For example, the user may look at a generated website where articles are organized by topic and may command the algorithm, in natural language, to rearrange the articles by author instead. The request may result in automatically generating author sub-topics in place of subject sub-topics.

At 510, method 500 includes creating a root folder with a folder name corresponding to the topic theme. In some examples, the LLM and/or algorithms may use weighting to determine the name of the root folder. The root folder may be a folder of the tree structure. The sub-folders of the tree structure may be organized within the root folder. Method 500 ends.

When a tree structure is generated or otherwise identified based on the folders stored in the CMS, file nodes may be automatically sorted into one or more sub-folders of the tree structure by the node sorting module. Method 600, shown in FIG. 6, is an example of a method for automatically generating the one or more sub-folders and sorting file nodes into the one or more sub-folders using the node sorting module. Method 600 may be automatically executed in response to the system identifying file nodes which are not included in a tree structure or upon a user adding a new file node to the CMS system. In some examples, method 600 may be executed automatically in response to a change in the tree structure causing the file nodes to demand resorting. In further examples, method 600 may be executed by a user when the user expects that some file nodes are miss-sorted.

At 602, method 600 includes analyzing contents of the file node metadata using the node sorting module. In some examples, the LLM may analyze the metadata of the file node. For example, the contents of the file node metadata may be input to the LLM as tokens and the LLM may determine a subject or subjects of the file node. In some examples, a computational efficiency of the method may be increased by inputting a portion of the file node metadata into the LLM. Inputting only a portion of the file node metadata into the LLM may reduce a total number of tokens used for analyzing the contents, thereby decreasing the computational resources demanded by the LLM. The portion of the file node input into the LLM may be selected by the user and/or automatically determined. For example, the file name may be input into the LLM and the remaining file node data may not be input to the LLM.

At 604, method 600 includes determining a sub-folder placement of the node using the node sorting module. A sub-folder may be a sub-folder of the root folder of the tree structure and may also be generally referred to as a folder of the tree structure. Determining the sub-folder placement may include comparing the analyzed metadata with the possible sub-folders included in the tree structure as generated by the tree structure generating module as described above. In some examples, the LLM may determine a sub-folder placement of a file node based on the analyzed metadata. In alternate examples, the analyzed metadata may be input to a weighted algorithm to determine a folder placement of the file node. For example, the algorithm may be weighted to consider a type of metadata more strongly than other types of metadata. For example, the content metadata may be highly weighted. Additionally or alternatively, metadata data such as author, file type and/or post date may be indicated by the user to have a higher weight in the node sorting module. The weights may change automatically in response to changes in the metadata. For example, weights may change as the subjects of the nodes and/or amount of file nodes change as content of the CMS changes.

At 606, method 600 includes determining if the sub-folder exists in the tree. In some examples, the sub-folder may be included in the generated tree structure as described above with respect to FIG. 5, but may have not yet been created in the tree structure and positioned inside the root folder of the tree structure.

If at 606, it is determined that the folder does not exist, method 600 proceeds to 608 and includes creating the folder and adding the folder to the tree structure. Method 600 than proceeds to 610 and includes placing the file node or alias file node in the folder identified at 604. The alias file node may be placed if the method determines the file node is placed in more than one folder of the one or more tree structures. If at 606, it is determined that the folder does exist, method 600 proceeds directly to 610.

At 612, method 600 includes updating connected file nodes and/or sibling file nodes, folders, alias file nodes, and alias folders. Updating connected nodes may include updating connections to related folders if a new folder is added. Updating at 612 may include updating the metadata and/or creating new metadata to reflect the new or changed connections. For example, new metadata may be based on new relationships to other file nodes, such as but not limited to, new sibling nodes, parent nodes, and child nodes. The connected nodes may be updated because placement of a node in the file tree may affect all related nodes. For example, if a node is placed in a folder it becomes a sibling to all other nodes in that folder. As another example, if a new child folder is formed method 600 may determine if any sibling folder or sub-child folder is already generated and connect the child folder accordingly. In another example, if a file is moved from one folder to a different one, the previous siblings may be updated to no longer be connected to the moved node. In this way, each file node may be sorted into a folder of the tree structure. The sorting may be done automatically by the node sorting module using an LLM and/or weighted algorithms. Method 600 ends.

The generated tree structure and sorted file nodes may be viewed by the user. Once sorted, the file nodes may be more comprehensively viewed by the user in such a way that any further demanded file nodes or folders are readily apparent. For example, a first sub-topic folder may have more child folders than a second sub-topic folder. In this way, the user may determine that additional content related to the second sub-topic is demanded. In some examples, a machine learning algorithm or LLM may ingest the completed tree structure and sorted file nodes and be configured to automatically suggest additional content to be added to the file system.

In some examples, the CMS may include a tree structure including sorted file nodes and the node module may sort new file nodes added by the user into the existing tree structure. In alternate examples, the CMS may include a separate tree structure from the tree structure into which the file node is being sorted, but the separate tree structure may include a similar topic theme or include a sub-folder which is similar to the topic theme. The node sorting module may include an algorithm, as shown in method 700 of FIG. 7, to take advantage of already sorted file nodes to inform sorting of new file nodes. Determining similarity between two file nodes or folder nodes may use less computationally demanding algorithms than those for determining folder placement of a file node. For example, determining similarity may only demand reading of certain types of metadata of each of the file and folder nodes, as described further below. File nodes which are determined to be similar to sorted file nodes may then be sorted in the same way without further use of other computational heavy algorithms. In this way, the node sorting module may be more processing efficient and may not rely as heavily on the LLM which incurs a high processing load and may save computing power and cost.

At 702, method 700 includes analyzing the metadata of the file node using the node sorting module. Analyzing the metadata may be similar to analyzing the metadata of the file nodes as described above with respect to step 602 of FIG. 6. In some examples, the method may be instructed by the user to analyze only certain categories of metadata when determining similarities. Analyzing only certain categories of metadata may help further decrease a processing power demanded for executing method 700.

At 704, method 700 includes automatically determining a similarity between the file node metadata and other stored file node metadata. The other stored file node metadata may be any stored and sorted file node metadata present in a data-holding subsystem (e.g., data-holding subsystem 104). The stored file node may be a file node which is stored in a folder of a tree structure. In some examples, the stored file node may be stored in the same tree structure as the file node being sorted. In alternate examples, the stored file node may be stored in a different but similar tree structure to the tree structure of the file node being sorted. As one example, a weighted algorithm may compare metadata, including but not limited to the metadata describing contents of the file node and assign a similarity score. The similarity score may correspond to the similarity of the weighted metadata of two different file nodes, one already sorted and the other to be sorted. A higher similarity score may indicate that the two file nodes are very similar. In some examples the weights may be similar to or the same as the weights used in the tree structure generating algorithm.

At 706, method 700 determines if the file node metadata is similar to the stored file node metadata. As one example, determining if the file node metadata and the stored file node metadata are similar may include determining if the similarity score is above a threshold level. If at 706, method 700 determines the file node metadata and the stored file node metadata are not similar, method 700 proceeds to 712 and includes determining the placement of the file node based on the analysis of the metadata as described above with respect to FIG. 6. Method 700 ends.

If at 706, method 700 determines that the file node metadata is similar to the stored file node metadata, method 700 proceeds to 708 and includes determining placement of the stored file node in the tree structure. The placement of the stored file node may include the folder of the tree structure in which the stored file node is stored. The tree structure of the stored file node may be the same or similar to the tree structure of the file node. At 710, method 700 includes placing the file node in the same folder of the tree structure as the stored file node. In some examples, the file node and stored file node may be in the same folder of the same tree structure or may be in similar corresponding folders of similar tree structures. In this way, when a file node is similar to already sorted and stored file nodes, the node sorting module may simply place the file node in the same folder and may demand less processing power than determining the folder placement based on using the LLM or other algorithms. Method 700 ends.

As described above, the LLM and/or machine learning algorithm may be used to analyze metadata of the file nodes, determine a tree structure and sort the file nodes into the tree structure. A block diagram 800 showing training and use of the LLM and/or machine learning algorithms of the automatic sorting system are shown in FIG. 8. Training inputs 802 may be input into the machine learning algorithms of the automatic sorting system. Training inputs 802 may include examples provided to the machine learning algorithm of acceptable tree structures and sorting of file nodes.

In some examples, the training inputs may include a collection of unsorted and sorted file node pairs 804. The unsorted and sorted file node pairs 804 may be unsorted file nodes that have been previously sorted into a tree structure. In some examples, the training inputs may include the unsorted file nodes paired with the associated tree structure and sorted file node pairs. The sorted file nodes and associated tree structure may be used as ground truth in the training data. The associated tree structure and sorted file node pairs may be previously generated or overseen by an expert user such as a web designer.

Additionally or alternatively, the training inputs may include related websites or sections of websites 806. The related websites or sections of websites may be from publicly available published websites. Sections of websites may include but may not be limited to breadcrumbs, navigation bars, schema, carousels, numbered lists, bulleted lists, tables, URLs, internal/external links, related pages/widgets, tags, and a search index based on a topic. In some examples, different website sections may be used as training examples for different aspects of generating a tree structure and assigning file nodes.

Internal/external links may be used as examples of connections formed between file and folder nodes of a tree structure. Certain internal links to other content or websites outside of the ecosystem can inform where to place nodes and can also be newly created metadata. Internal links to other content or data within the ecosystem can also help determine sorting and new metadata creation. The ecosystem may encompass the training inputs as described above.

As another example, a section of a website may include text of navigation bars and/or breadcrumbs of publicly available websites. In some examples, an algorithm may include instructions to identify and extract text from navigation bars to be used to train the machine learning algorithm as examples of a collection of folders on the same level of the tree structure. In some examples, text extracted from navigation bars may be used to train the machine learning algorithm as examples of folders on a high level (e.g., parent folders or root folders) of the tree structure. In further examples, an algorithm may include instructions to extract text of breadcrumbs displayed on a website. The text of the breadcrumbs may be input as training examples of a plurality of folders on progressive levels of the tree structure (e.g., a root folder, parent folder, and child folder). Automatically extracting text and inferring aspects of the tree structure using an algorithm may be more time efficient than manually providing training examples of tree structures based on the navigation bars and/or breadcrumbs.

Additionally or alternatively, the related websites may be public websites related to a general topic (e.g., sports, knitting, etc.) or purpose (retail, restaurant, reviews, etc.) of file nodes to be sorted by the automatic sorting system. In some examples an algorithm may extract a related website to determine a corresponding tree structure and file nodes of the related website. In some examples, the algorithm may extract positions of contents on the related website, including distance between content items. The distance between content items may be the physical distance between the content items when the website is displayed on a browser. For example, the distance may be measured in a number of pixels, number of lines, number of rows, or number of columns between the content items. In some examples, distance between content items may correspond to positions in the tree structure. The tree structure may be determined by parsing text of a navigation bar and/or breadcrumbs as described above. The corresponding file nodes may be determined by identifying content items of the website such as, but not limited to, a block of text, picture, embedded video, widget, related pages, and hyperlinks. Automatically extracting a tree structure and sorted file nodes of a website may be more time efficient than manually assigning a tree structure and file nodes to a website.

Additionally or alternatively, training inputs may include synthetic data 808. Synthetic data may be generated by an algorithm to complete a tree structure. For example, if a tree structure input from sorted/unsorted file node pairs 804 and from related websites 806 is incomplete, synthetic data 808 may be used to generate missing parts of the tree structure. Missing parts may include missing content and/or missing metadata.

Training inputs 802 may be input into the automatic sorting system 810 during training of the automatic sorting system 810. As described above, the automatic sorting system 810 may include a tree structure algorithm 812 and node sorting algorithm 814. The tree structure algorithm may be included in the tree structure generator module of FIG. 2 and the node sorting algorithm may be included in the node sorting module of FIG. 2. In some examples, tree structure algorithm 812 and node sorting algorithm 814 may be large language model algorithms.

File nodes 816 may be input into the automatic sorting system 810 during inference using the automatic sorting system 810. The file nodes may be unsorted file nodes, not associated with a tree structure, or may be miss-sorted file nodes which are associated with a tree structure, but not in a desired folder or a different tree structure is desired. The trained tree structure algorithm 812 and trained node sorting algorithm 814 may output a tree structure 820 and file nodes 822 sorted into the output tree structure 820.

A user may provide further adjustments to the automatically generated tree structure and sorted file nodes to produce user adjusted tree structure/file nodes 824. In one example, the user adjustments may be manual. In alternate examples, the user adjustments may be made by instructions (e.g., in natural language) input to automatic sorting system 810. For example, the user may move a file to adjust the tree structure. As another example, the user may demand re-sorting of the files using different weighting. User adjusted tree structure/file nodes 824 may be one of training inputs 802. In this way, how a user manipulates the tree structure over time is used in training the artificial intelligence/machine learning algorithms of automatic sorting system 810. Training inputs 802 therefore also include human (e.g., user) interactions with the tree structure and file nodes.

An example of a tree structure 900 including miss-sorted file nodes 906 is shown in FIG. 9A. Tree structure 900 may include a root folder 902. The root folder 902 may correspond to a topic theme of the file nodes. In the example of FIG. 9A, file nodes 906 all include content related to team sports. For this reason, root folder 902 may be titled team sports. Tree structure 900 may further include sub-folders (e.g., child nodes) 904. Sub-folders 904 may include a baseball sub-folder 904a, a football sub-folder 904b, and an ice hockey sub-folder 904c. Each sub-folder 904 may include a plurality of miss-sorted file nodes 906. Miss-sorted file nodes 906 may include file nodes with metadata that does not correspond to the sub-folder in which they are placed. For example, the baseball sub-folder 904a may include file nodes including metadata corresponding to football and/or ice hockey in addition to baseball.

An example of a website output using the tree structure 900 including unsorted file nodes 906 is shown in FIG. 9B. Website 950 may include a navigation bar 952. The titles included in the navigation bar may correspond to the sub-folders of tree structure 900. Website 950 may further include a first section 954. First section 954 may be located at top portion of a webpage and may be the first thing a viewer reads if reading the webpage from top to bottom. First section 954 may correspond to root folder 902. Website 950 may include a sub-section 956. Sub-section 956 may be a subsection of the first section 954. Sub-section 956 may include a plurality of links 958, each of the plurality of links 958 corresponds to one of the unsorted file nodes 906. Because the file nodes are unsorted the sub-section may not be organized in a way that is helpful for a viewer of the webpage. For example, the plurality of links 958 include a mixture of links about football, ice hockey, and baseball, and a viewer looking for information on a specific sport may not quickly find the information.

A user may wish to automatically sort the miss-sorted file nodes into sorted file nodes 1002 shown in FIG. 10A. The user may initiate the automatic sorting system. The user may further indicate to the automatic sorting system to sort the file nodes within tree structure 900. The automatic sorting system may generate metadata for each file node using the metadata analysis module as described above. The automatic sorting system may then sort each file node into one of sub-folders 904 based on the metadata using the node sorting module as described above. Sorted file nodes 1002 may be output as a result.

Sorted file nodes 1002 may correspond to a website. By having file nodes sorted into the tree structure, the system (e.g., visual display generation module 212) may use the tree structure to automatically and in real-time generate a cohesive website 1050, shown in FIG. 10B, directed to team sports. The website is generated automatically from the file nodes and the tree structure. Website 1050 may be similar to website 950 and similarly includes navigation bar 952 and first section 954. Because the website 1050 is automatically generated from sorted file nodes 1002, the system may automatically generate first sub-section 1052, second sub-section 1056, and third sub-section 1060. Each of the first, second, and third sub-sections may correspond to each of the sub-folders 904 of the tree structure 900. The first-sub section 1052 may include first links 1054 to content, each link of first links 1054 corresponding to a file node of tree structure 900 stored in the corresponding sub-folder 904a. Because the file nodes were automatically sorted, each of the first links 1054 is related to the subject of first sub-section 1052 (e.g., baseball). Similarly, the second sub-section 1056 corresponds to sub-folder 904b and includes second links 1058, and each of second links 1058 corresponds to the file nodes automatically sorted into sub-folder 904b. Further, the third sub-section 1060 corresponds to sub-folder 904c and includes third links 1062, and each of third links 1062 corresponds to file nodes automatically sorted into sub-folder 904c. In this way, the automatic sorting system may enable generation of websites from assorted file nodes without the user having to add manual tags to the contents. The generated website 1050 is correspondingly organized according to the automatic sorting of the file nodes. In this way, a useful website where a viewer may quickly identify all available articles pertaining to a sport of interest is automatically generated with little to no coding knowledge of the user.

Another example of a tree structure 1100 is shown in FIG. 11A. Tree structure 1100 may include a root folder 1102. A plurality of photographs 1104 may be stored directly in root folder 1102. The plurality of photographs 1104 may be examples of file nodes. Tree structure 1100 may not include sub-folders in which to further sort the plurality of photographs 1104.

FIG. 11B shows an example of website 1150 generated using tree structure 1100. Website 1150 may include a first section 1152. A title of first section 1152 may correspond to a title of root folder 1102. Photographs 1154 shown under first section 1152 may correspond to the plurality of photographs 1104. Because the tree structure 1100 does not include sub-folders the photographs 1154 may not be arranged in any particular way.

Turning now to FIG. 12A, a second tree structure 1200 is shown. Tree structure 1200 may include a similar root folder 1202 to tree structure 1100 and also includes sub-folders 1204. Sub-folders 1204 may include a first sub-folder 1204a titled nature photos and a second sub-folder 1204b titled people photos. Tree structure 1200 may be automatically generated by an automatic file sorting system, such as automatic file sorting system 204 discussed above. For example, a user may request the tree structure generation module to generate a new tree structure including at least two-sub folders related to subjects of the photographs. An automatic node sorting module may then automatically sort the nodes (e.g., the plurality of photographs 1104) into the sub-folders generated by the tree structure generation module.

Second tree structure 1200 may be used to generate website 1250 shown in FIG. 12B. Website 1250 includes a first section 1252, similar to first section 1152 of website 1150, corresponding to the root folder 1202. Because tree structure 1200 includes sub-folders, the generated website 1250 includes first sub-section 1254 and second sub-section 1258, each corresponding to sub-folders 1204 of tree structure 1200. Because the photographs are automatically sorted into the correct sub-folders, the first sub-section 1254 includes nature photographs 1256 corresponding to the photograph file nodes sorted into first sub-folder 1204a. Further, the second sub-section 1258 includes people photos 1260 corresponding to the photograph file nodes automatically sorted into second sub-folder 1204b. In this way, the display of photographs on website 1250 may be made more organized by applying the automatic sorting system to the contents of the website. The website may be organized with little to no coding performed by the user. For example, the user may request the re-sorting in plain language to automatically generate the resulting tree structure and website.

Turning now to FIG. 13A, an example of a tree structure 1300 is shown. Tree structure 1300 may include a root folder 1302. A plurality of different file nodes 1304 may be stored in root folder 1302. As one example, each of the different file nodes 1304 may correspond to file nodes used in visually generated and consumed content, such as a website. The file nodes stored in tree structure 1300 may include a plurality of different file types, such as spreadsheets, alias files, images, documents, and code as well as subsets of the different file types, such as files that are hidden and/or non-editable. The tree structure 1300 may not be useful if a user wishes to easily find all files of a certain type stored in tree structure 1300.

Turning now to FIG. 13B, an example of a plurality of tree structures 1350 is shown. The plurality of tree structures 1350 may be automatically generated by an automatic file sorting system, such as automatic file sorting system 204 of FIG. 2. A user may input to a tree structure generation module to generate a separate tree structure for each type of file node. The file nodes may then be automatically sorted into the separate tree structures by the node sorting module. The plurality of tree structures may each include a separate root folder. The root folders of the plurality of tree structures 1350 may each store a different type of file node. For example, a folder 1352 may correspond to documents and may store document file nodes. A second folder 1354 may correspond to code files and may store code file nodes. A third folder 1356 may correspond to images and may store image file nodes. A fourth folder 1358 may correspond to videos and may store video file nodes. A fifth folder 1360 may correspond to non-editable and/or hidden file nodes. A sixth folder 1362 may correspond to spreadsheets. A seventh folder 1364 may correspond to plugins. In this way the user may quickly and automatically re-sort the file nodes using the automatic file sorting system into the most useful tree structure and/or tree structures.

The technical effect of methods 300, 400, 500, 600, and 700 is to automatically generate visually arranged and consumed content from an unsorted collection of file nodes. Using an LLM and/or other machine learning algorithms may minimize the human time demanded for organizing an unorganized collection of content into a cohesive website or collection of other information, content, data, etc. Further, the methods provide examples to minimize the processing power demanded for the LLM based on determining similarities between unsorted file nodes and already sorted file nodes. As the stored content is updated and changed, the automatic file sorting system may repeatedly resort the file nodes as demanded and update the visually arranged and consumed content in real-time. In this way manual updating and reformatting of tags is avoided. By avoiding manual updating and reformatting of tags, the influence of human errors and/or inconsistencies are avoided. Further, the updating may be done in real-time as a background process so the most up-to-date tree structure is maintained.

The disclosure also provides support for a method of an automatic file sorting system executed via a processor based on instructions stored on non-transitory memory of the processor, the method comprising: analyzing contents of file nodes comprising content to be visually arranged and consumed, generating metadata for each of the file nodes based on the analyzed contents, the metadata including one or more of descriptive metadata, structural metadata, and administrative metadata, generating one or more tree structures corresponding to the file nodes based on the generated metadata, the one or more tree structures each including a root folder and one or more sub-folders providing a relational data structure, placing the file nodes into the one or more sub-folders of the one or more tree structures based on the generated metadata, and outputting a visual arrangement of the contents of the file nodes to a display, wherein the visual arrangement is based on a placement of the file nodes into the one or more sub-folders. In a first example of the method, generating the one or more tree structures includes determining one or more topic themes of the file nodes based on the generated metadata and creating the root folder of each of the one or more tree structures corresponding to the one or more topic themes. In a second example of the method, optionally including the first example, the one or more tree structures includes an alias file node and/or alias folder if a folder and/or file node is placed in more than one of the one or more tree structures. In a third example of the method, optionally including one or both of the first and second examples, generating metadata for each of the file nodes based on the analyzed contents includes generating metadata using a machine learning algorithm. In a fourth example of the method, optionally including one or more or each of the first through third examples, generating the one or more tree structures includes receiving a command in natural language, wherein the command includes to generate the one or more tree structures, wherein the natural language is translated to weights used in generating the one or more tree structures and/or to rearrange to the visual arrangement based on the one or more tree structures. In a fifth example of the method, optionally including one or more or each of the first through fourth examples, generating the one or more tree structures includes consuming a predefined tree structure via one or more of an API in a JSON or XML format, HTTP protocol, and direct upload. In a sixth example of the method, optionally including one or more or each of the first through fifth examples, determining the placement of file nodes includes automatically determining the placement using a large language model, further comprising inputting a portion of the generated metadata into the large language model to increase a computational efficiency of the method. In a seventh example of the method, optionally including one or more or each of the first through sixth examples, determining the placement of file nodes includes automatically determining the placement by comparing metadata of a file node to a stored file node of a generated tree structure and placing the file node in a sub-folder corresponding to a position of the stored file node in the generated tree structure if a similarity of the file node and the stored file node are above a threshold level.

The disclosure also provides support for a method of an automatic file sorting system executed via a processor based on instructions stored on non-transitory memory of the processor, the method comprising: generating metadata for file nodes based on analyzed content of the file nodes, the metadata including one or more of descriptive metadata, structural metadata, and administrative metadata, generating a tree structure based on the generated metadata using a tree structure algorithm trained using one or more of: sorted file nodes, navigation bars of websites, breadcrumbs of websites, synthetic data, and contents of related websites, wherein the tree structure includes a root folder and one or more sub-folders providing a relational data structure, sorting the file nodes into the one or more sub-folders based on the generated metadata using a node sorting algorithm trained using one or more of: sorted file nodes, navigation bars of websites, breadcrumbs of websites, and contents of related websites, and outputting a website comprising the contents of the file nodes, wherein a visual arrangement of the website is based on the sorting of the file nodes. In a first example of the method, the tree structure algorithm and the node sorting algorithm are machine learning algorithms. In a second example of the method, optionally including the first example, the method further comprises: automatically extracting the navigation bars of websites, the breadcrumbs of websites, and the contents of related websites from published websites, and wherein a distance between content items corresponds to a position in the tree structure. In a third example of the method, optionally including one or both of the first and second examples, the tree structure algorithm and node sorting algorithm are weighted algorithms based on weighting of the generated metadata, and wherein unsorted file nodes or miss-sorted file nodes are input for inference by the tree structure algorithm and node sorting algorithm. In a fourth example of the method, optionally including one or more or each of the first through third examples, a position of a sub-folder of the file nodes in the tree structure corresponds to a position of contents of the file nodes arranged on the website. In a fifth example of the method, optionally including one or more or each of the first through fourth examples, the tree structure algorithm and the node sorting algorithm are further trained using a user adjusted tree structure and file nodes.

The disclosure also provides support for a system for generating a website, comprising: a server in communication with a client system via a network, and a logic subsystem including one or more processors with instructions stored on non-transitory memory thereof that when executed cause the one or more processors to: analyze contents of file nodes comprising content to be visually arranged and consumed, generate metadata of each file node based on the analyzed contents, the metadata including one or more of descriptive metadata, structural metadata, and administrative metadata, analyze metadata of each file node using a large language model to sort the file nodes into a tree structure, wherein the tree structure includes a root folder and one or more sub-folders, wherein each of the file nodes is sorted into one of the one or more sub-folders, and output a visual arrangement of contents of each file node to a display based on where each file node is sorted into the tree structure. In a first example of the system, the instructions further cause the one or more processors to generate the tree structure based on the analyzed metadata, and wherein the tree structure is generated by inputting a file system to the logic subsystem. In a second example of the system, optionally including the first example, file nodes include one or more of text files, image files, audio files, video files, data files, coding files, and software applications. In a third example of the system, optionally including one or both of the first and second examples, the visual arrangement is a webpage and a pattern of the file nodes and the tree structure are used to efficiently place content, sections and/or widgets on the webpage. In a fourth example of the system, optionally including one or more or each of the first through third examples, the instructions further cause the one or more processors to automatically re-sort the file nodes in real-time in response to new file nodes added to the server or in response to adjustment of nodes by a user or an artificial intelligence algorithm. In a fifth example of the system, optionally including one or more or each of the first through fourth examples, the tree structure is represented as data and used as headless CMS, and wherein the data is in JSON or XML.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the systems described above with respect to FIG. 1. The methods may be performed by executing stored instructions with one or more logic devices (e.g., processors) in combination with one or more hardware elements, such as storage devices, memory, hardware network interfaces/antennas, switches, actuators, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and preceded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” “third,” and so on are used merely as labels, and are not intended to impose numerical requirements or a particular positional order on their objects. The following claims particularly point out subject matter from the above disclosure that is regarded as novel and non-obvious.

1. A method of an automatic file sorting system executed via a processor based on instructions stored on non-transitory memory of the processor, the method comprising:
analyzing contents of file nodes comprising content to be visually arranged and consumed;
generating metadata for each of the file nodes based on the analyzed contents, the metadata including one or more of descriptive metadata, structural metadata, and administrative metadata;
generating one or more tree structures corresponding to the file nodes based on the generated metadata, the one or more tree structures each including a root folder and one or more sub-folders providing a relational data structure;
placing the file nodes into the one or more sub-folders of the one or more tree structures based on the generated metadata; and
outputting a visual arrangement of the contents of the file nodes to a display, wherein the visual arrangement is based on a placement of the file nodes into the one or more sub-folders.

2. The method of claim 1, wherein generating the one or more tree structures includes determining one or more topic themes of the file nodes based on the generated metadata and creating the root folder of each of the one or more tree structures corresponding to the one or more topic themes.

3. The method of claim 1, wherein the one or more tree structures includes an alias file node and/or alias folder if a folder and/or file node is placed in more than one of the one or more tree structures.

4. The method of claim 1, wherein generating metadata for each of the file nodes based on the analyzed contents includes generating metadata using a machine learning algorithm.

5. The method of claim 1, wherein generating the one or more tree structures includes receiving a command in natural language, wherein the command includes to generate the one or more tree structures, wherein the natural language is translated to weights used in generating the one or more tree structures and/or to rearrange to the visual arrangement based on the one or more tree structures.

6. The method of claim 1, wherein generating the one or more tree structures includes consuming a predefined tree structure via one or more of an API in a JSON or XML format, HTTP protocol, and direct upload.

7. The method of claim 1, wherein determining the placement of file nodes includes automatically determining the placement using a large language model, further comprising inputting a portion of the generated metadata into the large language model to increase a computational efficiency of the method.

8. The method of claim 1, wherein determining the placement of file nodes includes automatically determining the placement by comparing metadata of a file node to a stored file node of a generated tree structure and placing the file node in a sub-folder corresponding to a position of the stored file node in the generated tree structure if a similarity of the file node and the stored file node are above a threshold level.

9. A method of an automatic file sorting system executed via a processor based on instructions stored on non-transitory memory of the processor, the method comprising:
generating metadata for file nodes based on analyzed content of the file nodes, the metadata including one or more of descriptive metadata, structural metadata, and administrative metadata;
generating a tree structure based on the generated metadata using a tree structure algorithm trained using one or more of: sorted file nodes, navigation bars of websites, breadcrumbs of websites, synthetic data, and contents of related websites, wherein the tree structure includes a root folder and one or more sub-folders providing a relational data structure;
sorting the file nodes into the one or more sub-folders based on the generated metadata using a node sorting algorithm trained using one or more of: sorted file nodes, navigation bars of websites, breadcrumbs of websites, and contents of related websites; and
outputting a website comprising the contents of the file nodes, wherein a visual arrangement of the website is based on the sorting of the file nodes.

10. The method of claim 9, wherein the tree structure algorithm and the node sorting algorithm are machine learning algorithms.

11. The method of claim 9, further comprising automatically extracting the navigation bars of websites, the breadcrumbs of websites, and the contents of related websites from published websites, and wherein a distance between content items corresponds to a position in the tree structure.

12. The method of claim 9, wherein the tree structure algorithm and node sorting algorithm are weighted algorithms based on weighting of the generated metadata, and wherein unsorted file nodes or miss-sorted file nodes are input for inference by the tree structure algorithm and node sorting algorithm.

13. The method of claim 9, wherein a position of a sub-folder of the file nodes in the tree structure corresponds to a position of contents of the file nodes arranged on the website.

14. The method of claim 9, wherein the tree structure algorithm and the node sorting algorithm are further trained using a user adjusted tree structure and file nodes.

15. A system for generating a website, comprising:
a server in communication with a client system via a network; and
a logic subsystem including one or more processors with instructions stored on non-transitory memory thereof that when executed cause the one or more processors to:
analyze contents of file nodes comprising content to be visually arranged and consumed;
generate metadata of each file node based on the analyzed contents, the metadata including one or more of descriptive metadata, structural metadata, and administrative metadata;
analyze metadata of each file node using a large language model to sort the file nodes into a tree structure, wherein the tree structure includes a root folder and one or more sub-folders, wherein each of the file nodes is sorted into one of the one or more sub-folders; and
output a visual arrangement of contents of each file node to a display based on where each file node is sorted into the tree structure.

16. The system of claim 15, wherein the instructions further cause the one or more processors to generate the tree structure based on the analyzed metadata, and wherein the tree structure is generated by inputting a file system to the logic subsystem.

17. The system of claim 15, wherein file nodes include one or more of text files, image files, audio files, video files, data files, coding files, and software applications.

18. The system of claim 15, wherein the visual arrangement is a webpage and a pattern of the file nodes and the tree structure are used to efficiently place content, sections and/or widgets on the webpage.

19. The system of claim 15, wherein the instructions further cause the one or more processors to automatically re-sort the file nodes in real-time in response to new file nodes added to the server or in response to adjustment of nodes by a user or an artificial intelligence algorithm.

20. The system of claim 15, wherein the tree structure is represented as data and used as headless CMS, and wherein the data is in JSON or XML.
